(19) United States
(12) Patent Application Publication
(10) Pub. No.: US 2022/0402246 A1
(43) Pub. Date: Dec. 22, 2022

(54) ORIENTED MULTILAYER SHRINK FILMS WITH POLYSTYRENE OR CYCLIC OLEFIN COPOLYMER SKIN LAYER

(71) Applicant: TAGHLEEF INDUSTRIES INC., Newark, DE (US)

(72) Inventors: Anthony J. DENICOLA, Old Lyme, CT (US); Andrew F. WILKIE, Avondale, PA (US)

(21) Appl. No.: 17/350,176

(22) Filed: Jun. 17, 2021

(51) Int. Cl. B32B 27/08; B32B 27/32; B32B 27/30; B32B 7/028

(52) U.S. Cl. CPC B32B 27/08; B32B 27/325; B32B 27/302; B32B 7/028; B32B 2270/00; B32B 2307/72; B32B 2307/412; B32B 2307/736; B32B 2307/516; B32B 2519/00; B32B 2250/03; B32B 2250/24

(57) ABSTRACT

Multilayer oriented shrink films include a base layer and at least one skin layer on at least one side of the base layer. The at least one skin layer includes at least one amorphous styrene-butadiene block copolymer or at least one amorphous cyclic olefin copolymer. The base layer has a thickness greater than the at least one skin layer and includes a blend of: (a) at least one styrene block copolymer selected from the group consisting of styrene-ethylene/butene-styrene triblock copolymers, styrene-ethylene/propylene-styrene triblock copolymers, styrene-ethylene/butene diblock copolymers and styrene-ethylene-propylene diblock copolymers and combinations thereof; and (b) at least one propylene polymer selected from the group consisting of polypropylene terpolymers with ethylene and butene-1, propylene ethylene copolymers, propylene butene-1 copolymers and combinations thereof.

### BACKGROUND OF THE INVENTION

### 1. Field of Invention

This invention relates generally to shrink films and more particularly to oriented multi-layer shrink films employing polystyrene or ethylene-norbornene copolymer (COC) in at least one skin layer.

### 2. Description of Related Art

Shrink labels represent a significant percentage of labelling applications. Within this category, high shrink labels are the fastest growing segment because of the trend towards contoured containers and shrink sleeve labels with 360° graphics. There are two categories of shrink labels: roll-on-shrink-on (ROSO) labels and sleeve labels. Films from which ROSO labels are formed primarily shrink in the machine direction (MD) and generally employ biaxially oriented polypropylene (BOPP) films with shrink levels of generally less than 20%. Sleeve labels are solvent seamed into a tube and placed around a container. When heat is applied, the label preferentially shrinks in the direction extending circumferentially around the container. Sleeve labels primarily shrink in the transverse direction (TD) of film formation.

Current high shrink sleeve labels are made from TD shrink films (i.e., films with predominate shrinkage in the transverse direction of film formation). These films can provided 50% or more shrinkage and are usually made of polyvinyl chloride (PVC), polyethylene terephthalate (PET), polyethylene terephthalate glycol (PETG), polylactic acid (PLA) or oriented polystyrene (OPS).

PVC and PETG are the predominant shrink films in North America. These polymers contaminate the PET in labeled containers and in the recycling process must be separated. Since PETG and PET have similar characteristics, there is no elegant way to segregate them. Recyclers and brand owners are interested in preserving the value of recycled PET employed in the fabrication of containers. A shrink label that floats in water allows easy separation from PET bottles and preserves the recyclability of the container. Numerous commercial prior art label structures employing PVC, PET, PETG, PLA and OPS have densities in excess of 1 g/cm³ making it difficult to separate the labels from the containers to which they are attached during a recycling process. In other words, they are not floatable. In addition, there is a push to avoid PVC packaging because of environmental concerns. OPS offers low cost and high shrinkage, but prior to this invention, optics and rigidity have not been of the desired quality in prior art structures.

Representative publications disclosing multilayer shrink films employing polystyrene in at least one skin layer include:

US 20150010740, assigned to Avery Dennison: Discloses a five-layer film with both skins including 90% polystyrene homopolymer and 10% styrene-ethylene-co-butene-styrene block copolymer. When the skin is a styrene block copolymer (SBC), it is a five-layer structure wherein tie layers between the core and skins either are 100% SEPS or a blend of LDPE (10%) and a maleic anhydride grafted polyolefin (90%). The core composition is 90% LDPE (a blend of two LDPE grades) and 10% propylene-based elastomer copolymer. Both films with SBC skins, which were oriented in the MD direction, exhibited very poor MD shrink performance at 90° C. of 10% and 9% with the 100% SEPS and LDPE/Maleic anhydride polyolefin tie layers, respectively. This level of shrink performance is insufficient for high shrink label applications.

U.S. Pat. No. 5,219,666, assigned to WR Grace: Discloses an oriented multilayer film with a core layer of very low density polyethylene and outer layers comprising a styrene-butadiene copolymer. The film is made by a blown film process with very low 2.5:1 uniaxial stretching in the machine direction. In a five-layer structure, ethylene-vinyl acetate copolymer is used as the tie-layers. These films were primarily designed to replace PVC films for overwrapping trayed food products where hot plate seals could be formed at 220° F. (104° C.) without undue film shrinkage, or for shrink labels where a shrink temperature of 300° F. (148.8° C.) was used. These films would not be suitable for use in PET bottle shrink label applications and steam shrink tunnel processing applications.

U.S. Pat. No. 8,541,077, assigned to Dow Global Technologies: Discloses a five-layer film structure in which the core layer is a 100% polypropylene plastomer. The outer skins layers are polystyrene homopolymer or a blend of polystyrene homopolymer and styrene-butadiene block copolymer. Tie layers between the core and skin layers are an elastomeric styrene-ethylene-co-propylene triblock copolymer. This patent states that the disclosed films desirably demonstrate a shrinkage under normal shrink label application temperatures (for example from 110° C. to 140° C. for RO SO or from 110° C. to 130° C. for sleeve) in the preferred orientation direction (when oriented at a temperature from 120° C. to 130° C.) of 20 percent or more, preferably 30 percent or more, more preferably 40 percent or more, still more preferably 50 percent or more, yet more preferably 60 percent or more, even yet more preferably 70 percent or more. At 105° C., the disclosed shrink level in the direction of orientation of the films generally is in the range of <20-35%. These films would not be suitable for PET bottle shrink label applications and steam tunnel processing applications.

US 20160107422, assigned to Seal Air: Discloses a five-layer film structure in which the base (core) layer is an ethylene/alpha-olefin copolymer (LLDPE or VLDPE), alone or in combination either with 20% ethylene-norbornene copolymer (COC) or with 10% styrene-butadiene-styrene (SBS) copolymer. The skins are styrene-butadiene block copolymers (SBC), styrene-isoprene block copolymer (SIS), SEBS, SEPS, or SEP polymers. The intermediate, or tie layers in all examples are a combination of 80-90% EMA and 10-20% SEBS.

U.S. Pat. No. 7,935,401, assigned to Cryovac: Discloses in all examples films including a base (core) layer having a linear low density polyethylene (LLDPE) or very low density polyethylene (VLDPE) together with one or more ethylene-norbornene (COC) polymers, and skin layers including 100% PETG.

U.S. Pat. No. 80,929,200, assigned to Dow Global Technologies: Films are produced in a blown film process. The inner (core) layer has at least one stiffening polymer selected from the group consisting of LDPE, LLDPE, HDPE or blends thereof, polypropylene random copolymer, styrene-butadiene block copolymer (SBS), polystyrene, ethylene-vinyl acetate copolymer (EVA) or ethylene-norbornene (COC) copolymer. The opposed skin layers, which may be the same or different, comprise at least one of LDPE, a blend of LDPE and LLDPE, a blend of LDPE and VLDPE, polystyrene, EVA, blends of EVA and LLDPE, COC, SBC, or polypropylene random copolymers. As indicated in the examples, where polystyrene skin layers are used, the films are designed for shrink performance in the direction of maximum orientation greater than 44% at a shrink temperature greater than 120° C. These films would not be suitable for PET Bottle shrink label applications and steam tunnel processing applications.

US 20030068453, assigned to ExxonMobil: Skin layers of the disclosed multilayer films either are 100% of an amorphous copolyester or are blends of amorphous copolyester with acid/acrylate grafted plastomer. The core layer includes polyethylene, polypropylene, and copolymers of ethylene and one or more alpha-olefins. In all the examples, the core layer is either an ethylene-octene copolymer, a blend of LLDPE (60%) and amorphous copolyester (40%) or a blend of LLDPE (50%) and amorphous copolyester (50%). In five-layer structures, the tie layers are a mixture of LLDPE and acid/acrylate graft plastomer. While the films of this disclosed invention are described as being designed for use as a shrink sleeve label, shrink performance data is provided only at 121° C. and 7 minutes of exposure, and two of the four examples only. Shrink levels of 45% and 52% were achieved, respectively. This strongly suggests that these films would not be suitable for PET bottle shrink label applications and steam tunnel processing applications where high shrink levels at temperature levels ranging from 80-95° C. and short residence times are required.

Accordingly, it is desired to provide multilayer oriented shrink films that do not suffer from the aforementioned deficiencies of other films.

All references cited herein are incorporated herein by reference in their entireties.

### BRIEF SUMMARY OF THE INVENTION

Accordingly, a first aspect of the invention comprises a multilayer oriented shrink film comprising:
a base layer; and
a first skin layer on a first side of the base layer and comprising at least one amorphous styrene-butadiene block copolymer or at least one amorphous cyclic olefin copolymer,
wherein the base layer has a thickness greater than the first skin layer and comprises a blend of: (a) at least one styrene block copolymer selected from the group consisting of styrene-ethylene/butene-styrene triblock copolymers, styrene-ethylene/propylene-styrene triblock copolymers, styrene-ethylene/butene diblock copolymers and styrene-ethylene-propylene diblock copolymers and combinations thereof; and (b) at least one propylene polymer selected from the group consisting of polypropylene terpolymers with ethylene and butene-1, propylene ethylene copolymers, propylene butene-1 copolymers and combinations thereof.

In certain embodiments of the first aspect of the invention, the film comprises a second skin layer on a second side of the base layer opposite to the first side of the base layer, wherein the second skin layer comprises at least one amorphous styrene-butadiene block copolymer or at least one amorphous cyclic olefin copolymer.

In certain embodiments of the first aspect of the invention, the film comprises a second skin layer on a second side of the base layer opposite to the first side of the base layer, wherein the second skin layer has a composition identical to a composition of the first skin layer.

In certain embodiments of the first aspect of the invention, the film has a density of less than 1 g/cm³.

In certain embodiments of the first aspect of the invention, the base layer further comprises a polypropylene copolymer elastomer.

In certain embodiments of the first aspect of the invention, the base layer further comprises a polybutene-1 copolymer.

In certain embodiments of the first aspect of the invention, the film has a haze less than 6%.

In certain embodiments of the first aspect of the invention, a predominant film orientation is in a transverse direction, and the film has a transverse direction shrink level in excess of 50% at 95° C.

In certain embodiments of the first aspect of the invention, a predominant film orientation is in a transverse direction, and the film has a transverse direction shrink level in excess of 60% at 95° C.

In certain embodiments of the first aspect of the invention, the film is uniaxially oriented in a transverse direction, and the film has a transverse direction shrink level in excess of 50% at 95° C.

A second aspect of the invention comprises a multilayer oriented shrink film comprising:
(A) a base layer comprising:
   (i) at least one styrene block copolymer selected from the group consisting of styrene-ethylene/butene-styrene triblock copolymers, styrene-ethylene/propylene-styrene triblock copolymers, styrene-ethylene/butene diblock copolymers, styrene-ethylene-propylene diblock copolymers and combinations thereof;
   (ii) 20% to 55% at least one polypropylene polymer selected from the group consisting of polypropylene terpolymers with ethylene and butene-1, propylene ethylene copolymers, propylene butene-1 copolymers and combinations thereof; and
   (iii) at least one of: (a) 1% to 30% of a polypropylene elastomeric copolymer, and (b) 1% to 10% of polybutene-1 with ethylene; and
(B) at least one skin layer which is disposed upon at least one side of the base layer, wherein the at least one skin layer comprises at least one amorphous styrene-butadiene block copolymer or at least one amorphous cyclic olefin copolymer, and wherein the base layer has a thickness greater than that of the at least one skin layer
wherein the at least one styrene block copolymer constitutes 45%-75% of the base layer when the at least one skin layer comprises the at least one amorphous styrene-butadiene block copolymer, and the at least one styrene block copolymer constitutes 30%-75% of the base layer when the at least one skin layer comprises the at least one amorphous cyclic olefin copolymer.

In certain embodiments of the second aspect of the invention, the film has a haze less than 6%.

In certain embodiments of the second aspect of the invention, a predominant film orientation is in a transverse direction, and the film has a transverse direction shrink level in excess of 50% at 95° C.

In certain embodiments of the second aspect of the invention, a predominant film orientation is in a transverse direction, and the film has a transverse direction shrink level in excess of 60% at 95° C.

In certain embodiments of the second aspect of the invention, the film is uniaxially oriented in a transverse direction and has a transverse direction shrink level in excess of 50% at 95° C.

In certain embodiments of the second aspect of the invention, the film comprises: (a) 1% to 30% of the polypropylene elastomeric copolymer, but not (b) 1% to 10% of the polybutene-1 with ethylene.

In certain embodiments of the second aspect of the invention, the film comprises: (b) 1% to 10% of the polybutene-1 with ethylene but not (a) 1% to 30% of the polypropylene elastomeric copolymer.

In certain embodiments of the second aspect of the invention, the film comprises: (a) 1% to 30% of the polypropylene elastomeric copolymer, and (b) 1% to 10% of the polybutene-1 with ethylene.

In certain embodiments of the second aspect of the invention, the film has a haze less than 3%.

In certain embodiments of the second aspect of the invention, the film has a haze less than 2%.

In certain embodiments of the second aspect of the invention, the base layer further comprises a non-voiding opacifying agent.

In certain embodiments of the second aspect of the invention, the film has a density of less than 1 g/cm³.

In certain embodiments of the second aspect of the invention, the film has a UV-Visible light transmission at wavelengths between 200 nm and 800 nm of less than 10%.

In certain embodiments of the second aspect of the invention, the film has a UV-Visible light transmission at wavelengths between 200 nm and 800 nm of less than 15%.

In certain embodiments of the second aspect of the invention, the film has a UV-Visible light transmission at wavelengths between 200 nm and 800 nm of less than 1%.

A third aspect of the invention comprises a shrink label comprising a multilayer oriented shrink film of the invention, wherein the label is configured to be wrapped about a peripheral surface of an article with one end of the label overlapping and sealed to an outer surface of the first skin layer at an opposite end of the label, and wherein the outer surface of the first skin layer is capable of being tackified by a solvent blend so as to adhere to the one end of the label.

In certain embodiments of the third aspect of the invention, the first skin layer includes a cyclic olefin copolymer therein.

In certain embodiments of the third aspect of the invention, the first skin layer includes an amorphous styrene-butadiene block copolymer therein.

### BRIEF DESCRIPTION OF THE DRAWINGS

The invention will be described in conjunction with the following drawings in which like reference numerals designate like elements and wherein:

FIG. 1 is a graph showing UV-VIS Spectrophotometry in the range of 200 nm to 800 nm wavelength of Example 3 and Example 12. Light transmission of the shrink films were recorded as a function of wavelength, demonstrating the light blocking effectiveness of the opaque film (Example 12) as compared to the optically clear film (Example 3).

FIG. 2 is a graph showing UV-VIS Spectrophotometry in the range of 200 nm to 800 nm wavelength of Example 14. Light transmission of the shrink film was recorded as a function of wavelength, demonstrating the light blocking effectiveness of the opaque film.

### DETAILED DESCRIPTION OF PREFERRED EMBODIMENTS OF THE INVENTION

### Definitions and Description of the Test Methods

Unless specified otherwise the following terms shall have the specified meanings set forth below:

“Olefin polymer” means a homopolymer, copolymer or terpolymer in which all of the monomer units in such polymers are olefins.

“Propylene polymer” means a propylene homopolymer, or a copolymer or a terpolymer in which the predominant monomer component by weight is propylene.

“Propylene terpolymer” or “polypropylene terpolymer” means a propylene, ethylene, butene terpolymer in which propylene is the predominant monomer unit by weight.

“Propylene ethylene copolymer” or “polypropylene ethylene copolymer” and “propylene butene-1 copolymer” or “polypropylene butene-1 copolymer” means propylene ethylene or propylene butene-1 copolymer in which propylene is the predominant monomer unit by weight.

“Polypropylene homopolymer” includes, in addition to a homopolymer, a polypropylene ethylene copolymer in which the percentage of ethylene is so little that it does not adversely affect the crystallinity or other properties of the propylene homopolymer. These copolymers are referred to as “minirandom” copolymers and have a percentage of ethylene, by weight of the copolymer, of 1% or less.

“MFR” is measured according to ASTM D1238. Temperature in ° C. and applied weight in kg are reported in the format MFR (temperature/weight), i.e. MFR (230/2.16).

The thermal properties have been determined by “DSC “or differential scanning calorimetry, taking the melting temperature from 2^{nd} heating and crystallization temperature using a heating and cooling rate of 10 K/min between −50 and 250° C.

“Percent shrinkage” in referring to the shrinkage of a film or a label formed from such film is calculated in accordance with the following formula:

$$\frac{( Dimension prior to shrinkage - Dimension after shrinkage ) \times 100}{Dimension prior to shrinkage}$$

“Haze” is reported as a percentage and is determined in accordance with ASTM D1003 test method.

“Density” of the film or label formed therefrom is determined by the displacement procedure of ASTM D792 test method.

“Flexural Stiffness”, or “Flex Stiffness”, measures the stiffness or bending resistance of plastic films using an MTS/Sintech Q-Test Model QT-5 or similar instrument, a 2N (200 g) load cell, a triangular shaped stirrup attached to the load cell and a film holding fixture with a 1 inch wide channel which holds the film in the form of an arc. Film sample length is 4 inches with width between 1 and 4 inches. Crosshead speed is 12 inches/min with maximum compressive force required to bend the film sample at the center of the arc being measured. Results are reported as grams per inch width (peak grams divided by sample width in inches).

“Gloss” of the film or label formed therefrom is determined in accordance with ASTM 2457 test method. “Gloss in” refers to the gloss of the inside surface of the produced mill roll and “gloss out” refers to the gloss of the outside surface of the produced mill roll.

“Dynes/Wetting Tension” is determined in accordance with ASTM 2578 test method.

“Opacity” of the film or label formed therefrom is determined in accordance with TAPPI T425 test method.

“MD” and “TD” refer to the machine direction and the transverse direction in the manufacturing process, respectively.

“MD and TD Gurley stiffness” of the film or label formed therefrom was determined in accordance with ASTM D6125 test method.

“Blocking” is a test to determine the blocking tendency of two layers or sheets of a film brought into contact under high pressure as expected to occur during winding, handling, shipment or warehousing . . . . This method consists of placing two sheets of film surfaces together in a jig with inside against outside surfaces and applying 150 psi of compression for 24 hours at room temperature or 3 hours at 35° C., and then determining the force required to separate them. Peak and peel average values are reported as grams/inch of width.

“Pin Puncture” measures the puncture resistance of plastic films using an MTS/Sintech Q-Test Model QT-5 or similar instrument, a 250N (50 lb.) load cell, a puncture resistance test adapter in the lower jaw and a 1 inch specimen grip in the upper load cell. Crosshead speed is 12 inches/min with the force required to puncture the film sample being measured. Results are reported as grams of force.

“Measured Thickness” is determined by cross-section microtoming a thin slice of the film and viewing the cross-section under a scanning electron microscope with a calibrated image scale to determine individual layer thicknesses of the multilayer film.

“TD shrink tension” of the film or label formed therefrom is determined in accordance with ASTM D2838 test method.

“MD and TD shrink” is determined in hot oil as a function of temperature in accordance with ASTM D1204 test method.

“Natural shrink” of the film is the unconstrained % shrink of a film sample after exposure to a prescribed temperature after a defined period of time. As described in the following examples, sample hand sheets, typically 8.5 inches (21.6 cm) by 11 inches (27.9 cm) are cut from the roll in the TD direction. The sample is placed without constraints in a hot air oven set at the prescribed temperatures (typically 30° C., 35° C., 40° C., and 45° C.) for 24 hours. Sample dimensions in the MD and TD direction are measured before and after heat exposure and the percentage shrink is calculated from the change in the measured dimensions.

“Z Axis Strength” is the measure of the inter-laminar strength of a film specimen and covers measurement of the forces exerted when a specimen is pulled apart in the Z direction (i.e., through the cross-section). Scotch 610 tape (1 inch width and 8 inches long) is applied to both sides of the film specimen with moderate pressure to ensure that the tape has adhered to the sample on both sides. The two tapes are initially pulled apart manually to initiate inter-laminar failure. Once the z-axis failure has been initiated, the two tape tabs of the sample are placed in a MTS Q-Test/1 L tensile tester or similar instrument (25N cell) and separated at a cross head speed of 35 inches/minute. The peak and peel force is recorded and reported as grams per inch of width. If the sample does not initiate or fail by interlaminar separation, it is reported as “could not delaminate”

“Seam T-peel Strength (peak and peel)” measures the strength of solvent bonded overlap seams of the shrink film. Film samples are hand seamed into shrink sleeves using a laboratory seamer (available from Ryback & Ryback, Inc., Monroe, N.C.). Seam width for all films was kept within a range of 0.15-0.3 inches (4-7.5 mm). Samples strips from the resulting sleeves were aged at room temperature for several hours prior to T-peel testing on a MTS Q-Test/1 L tensile tester with a 100 N load cell. The overlapping seam is laterally centered between the jaws with the tail facing the back at a 90° angle. The specimens are then mechanically pulled apart at a crosshead speed of 305 mm/min to determine the force required to separate the seal. The force to initiate and force to peel are measured and then normalized to one inch of width. Values are reported as grams/inch.

“UV-Visible Light Transmittance” was measured on a UV-VIS Spectrophotometer capable of automated scanning between wavelength of 200 nm and 800 nm. Transmission reading were collected every 1 nm wavelength.

“Yield” is the coverage in square inches/pound (in.²/lb.) and is determined in accordance with ASTM D4321 test method.

“Uniaxial” in specifying the direction of orientation of films of this invention refers to films in which the draw ratio in one direction (MD or TD) is less than 1.4× and the draw ratio in the opposed, or orthogonal direction is greater than 2.0×. In such a film the uniaxial direction of orientation is the direction in which the film is stretched more than 2.0×.

“Biaxial” in specifying the direction of orientation of films of this invention refers to films in which the draw ration in both the MD and TD directions is greater than 2.0×.

“Calculated Thickness (μm)=702,538/(yield*density), where yield units are in²/lb. and density units are g/cm³.

Shrink Films

A first aspect of the invention relates to multilayer oriented shrink films with a base layer (sometimes referred to herein as a “core layer”) and at least one skin layer. The base layer comprises a blend of at least one styrene block copolymer from the group consisting of styrene-ethylene-co-butene, styrene-ethylene-co-propylene, styrene-ethylene-co-butene-styrene, or styrene-ethylene-co-propylene-styrene block copolymer, and at least one propylene copolymer or terpolymer from the group consisting of polypropylene terpolymers, propylene ethylene random copolymers and propylene butene-1 random copolymers, or combinations thereof. Among the styrene block copolymers those with diblock, triblock, or tetrablock structures and combinations of two or more are preferred. Among the propylene copolymers those with an ethylene content of 4.0-7.0 wt.-%, by weight of the copolymer, and with a butene-1 content of 7-22 wt.-% by weight of the copolymer are most preferred. The at least one skin layer includes at least one styrene-butadiene block copolymer or at least one cyclic olefin copolymer. The base layer may optionally include at least one polypropylene elastomeric copolymer, and optionally at least one polybutene copolymer.

The inventive films are useful for the manufacture of labels, in particular solvent seamed sleeve labels, with shrink to conform to the shape of the container when heated at temperatures compatible with those encountered in a steam tunnel.

In a preferred embodiment of this invention the oriented, multilayer shrink film has shrinkage in one direction of formation, most preferably the transverse direction of formation, of at least 40%, and more preferably at least 50%, and most preferably at least 60%, when heated in the temperature range of 90-100° C. Most preferably at least 60% shrinkage in at least one direction, preferably the transverse direction of formation, is achieved in the temperature range of 93-97° C.

In the most preferred embodiments, when the films employed in the formation of labels for attachment to containers and bottles, it is desirable to form the films with a density less than 1 g/cm³; most preferably significantly below 1 g/cm³, e/g., less than 0.96 g/cm³ and more preferably less than 0.94 g/cm³. Particularly for shrink sleeve applications requiring full-body graphics, the print layers can add as much as 0.03 g/cm³ density to the base film so densities below 0.96 g/cm³ for the base film is highly desirable and permits the labels to be easily separated from the heavier containers, which have a density greater than 1 g/cm³, during the recycling process. However, in applications where separation for a heavier article is not desired or required, the films of this invention may have a density greater than 1 g/cm³. Also, when opaque films are formed with the addition of an opacifying agent, such as TiO₂, films with a density below 1 g/cm³ or above 1 g/cm³ can be provided, depending upon the concentration of opacifying agent required.

In other embodiments of the invention the core layer can include shrink film reclaim, polypropylene elastomeric copolymers (with ethylene), alone or in combination. Incorporating these additional components into the film core provides several beneficial improvements.

In preferred embodiments when reclaim is employed in the core layer it includes a styrenic diblock and/or triblock copolymer with ethylene-co-butene or ethylene-co-propylene segments, polypropylene terpolymer, styrene-butadiene block copolymer and/or ethylene-norbornene copolymer (COC); most preferably the reclaim is from the same film structure being formed and includes the components in the skins and core layer that are the same as the film being formed with the reclaim in it.

In accordance with this invention the overall thickness of oriented films employed to form bottle labels can range from 10 microns to 90 microns, more preferably from 12 microns to 75 microns; even more preferably from 40 microns to 65 microns. In the most preferred embodiments of this invention, the film is a multilayer film including a core layer between opposed skin layers.

Preferably, when the skin layer is one or more cyclic-olefin copolymers, the minimum skin thickness on one or both surfaces is greater than 9% of the overall film thickness; more preferably greater than 10% of the overall film thickness; even more preferably greater than 12% of the overall film thickness and most preferably in excess of 13% of the overall film thickness. When the skin layer is one or more styrene-butadiene block copolymers, the minimum skin thickness on one or both surfaces is greater than 9% of the overall film thickness; more preferably greater than 12% of the overall film thickness and most preferably in excess of 15% of the overall film thickness.

In a representative embodiment of this invention, oriented multilayer shrink film of this invention includes at least three layers—a core layer having a thickness of at least 20 microns (more preferably in the 30-35 micron range) and two opposed skin layers each of which has a thickness that preferably is greater than 5 microns, and more preferably greater than 6 microns.

Labels

This invention also includes container labels made from the oriented, multilayer shrink films of this invention.

Most preferably a container label of this invention is in the form of a sleeve having a circumferential dimension configured to surround a periphery of a container and a transverse direction substantially normal to said circumferential direction, said circumferential dimension being the dimension with the greatest shrinkage when said label is heated to a desired temperature no greater than 100° C. to effect shrinkage. The at least one amorphous styrene-butadiene block copolymer or at least one amorphous ethylene-norbornene copolymer (COC) in the skin layers permits effective solvent seaming, which is highly desirable in sleeve labels. In the preferred embodiment the label is formed from a film in which the TD direction of film formation is the direction of greatest shrinkage, and this transverse direction of formation constitutes the circumferential direction of the label surrounding the container.

Most preferably the circumferential dimension of the container label is the transverse dimension of formation of the oriented, multilayer film from the label is formed.

Most preferably the films and/or labels made from these films have high stiffness, low natural shrink together with directional shrink at 95° C. as high as 65%, haze less than 5% (in clear films/labels of the invention) with clarity greater than 60%, and density less than 1.0 g/cm³ to facilitate easy separation from PET containers during recycling after use, and a broad orientation processing window.

These films are useful for the manufacture of labels, in particular solvent seamed sleeve labels, which shrink, when heated at temperatures compatible with the use of a steam tunnel for heat transfer, to conform to the shape of the container. The preferred multilayer films of this invention have a density of less than 1 g/cm³.

In preferred embodiments of this invention the multilayer shrink film is a three layer film which includes a skin layer on each of the opposite sides of the core layer. Five layer films are within the broader scope of the invention which would include an interlayer on each side of the core layer between the core layer and each skin layer, characterized in that each of the skin layers includes at least one amorphous styrene-butadiene block copolymer or ethylene-norbornene copolymer and each optional interlayer includes at least one copolymer from the group consisting of styrene-ethylene/butene-styrene triblock copolymers, styrene-ethylene/propylene-styrene triblock copolymers, styrene-ethylene/butene diblock copolymers, styrene-ethylene-propylene diblock copolymers, styrene-ethylene/propylene-styrene-ethylene/propylene tetrablock copolymers and combinations of two or more of said tetrablock, triblock and diblock copolymers.

Preferably the composition of the skin layers on opposite sides of the core or base layer are of the same composition; including at least one amorphous styrene-butadiene block copolymer or at least one amorphous ethylene-norbornene copolymer therein.

The composition of the core or base layer in a five layer structure is the same as described earlier, including the specified required and optional components.

In the most preferred embodiments the shrink films are transparent, having a haze less than 6%. However, opaque films employing a non-voiding whitening agent therein are within the broad scope of this invention. However, the latter non-voided embodiments generally will have a density greater than 0.95 g/cm³ and may have a density above 1.0 g/cm³.

In the preferred embodiments of this invention the predominant film orientation of the multilayer oriented shrink films is in the transverse direction, said film having a transverse direction shrink level in excess of 50%, and more preferably in excess of 60% at 95° C.

In the most preferred embodiments of this invention, the base layer comprises at least one copolymer from the group consisting of styrene-ethylene/butene-styrene triblock copolymers, styrene-ethylene/propylene-styrene triblock copolymers, styrene-ethylene/butene diblock copolymers, styrene-ethylene-propylene diblock copolymers, styrene-ethylene/propylene-styrene-ethylene/propylene tetrablock copolymers and combinations of two or more of said tetrablock, triblock and diblock copolymers, a propylene-ethylene-butene terpolymer with the predominant monomer being propylene, and a polypropylene elastomeric copolymer which is a semi-crystalline propylene/ethylene copolymer including over 80%, by weight, propylene.

In the most preferred embodiments of this invention the shrink film is a three-layer or five-layer film including skin layers on opposite sides of the core layer and in engagement therewith in the case of three-layer films or in engagement with intermediate tie layers between the core layer and skin layers in the case of five-layer films.

Applicant has found that combination of styrene block copolymers with ethylene/butene or ethylene/propylene, polypropylene terpolymer (with ethylene and butene) and optionally polypropylene elastomeric copolymers (with ethylene) and/or optionally polybutene-1 copolymers (with ethylene) at a low level (less than 10 wt. %), when used in the core or base structure of a multilayer film with at least one skin layer comprising at least one amorphous polystyrene-butadiene block copolymer or cyclic olefin copolymer with norbornene exhibits a very attractive balance of properties. The films and/or labels made from these films have high stiffness, low natural shrink together with directional shrink at 95° C. greater than 50%, haze less than 6% (in translucent/transparent embodiments) and density less than 1.0 g/cm³, and a broad orientation processing window. Low density shrink films of less than 1.0 g/cm³ is preferred to facilitate easy separation of the shrink labels from PET containers during recycling after use.

In addition, the films of this invention employing polystyrene skin layers have an earlier shrink initiation point and a more moderate (i.e., gradual) temperature response to shrink as compared to shrink films employing skin layers formed with cyclic olefin copolymer and glycol-modified polyethylene terephthalate. A moderate temperature response and moderate shrink tensions achieved in the shrink films of this invention are highly desirable in many shrink film applications, as better control is provided over the labeling process, a higher quality label application results, and there is a reduced tendency of label shrinkage collapsing thin walled containers.

The following describes a number of embodiments of this invention. A general description of the embodiments, including the identification of optional components in the core or base layer is depicted below.

Corona Treatment (optional)

| | |
|---|---|
| ~4-13 μm-skin layer | One or more Styrene-butadiene-Styrene block |
| | copolymers or Cyclic olefin copolymers |
| 20-45 μm-core layer | 45-65% SEBS or SEP or SEPS Block Copolymers |
| | 20-55% Propylene terpolymer or high ethylene |
| | propylene copolymer |
| | 0-30% Propylene elastomer |
| | 0-10% Polybutene-1 copolymer with ethylene |
| | 0-25% Reclaim |
| | 0-15% Polybatch White LL8006 CT or 8000 EC |
| | TiO₂ Concentrate |
| ~4-13 μm-skin layer | One or more Styrene-butadiene-Styrene block |
| | copolymers or Cyclic olefin copolymers |

Corona Treatment (optional)

Polymers

Styrene Polymers

Styrene-Butadiene-Styrene block copolymers are commercially available from Ineos Styrolution America, LLC, Aurora, Ill. or its distributor, PolyOne Corporation, Littleton, Mass. General purpose polystyrene homopolymers are commercially available from American Styrenics, The Woodlands, Tex. or its distributor PolyOne Corporation, Littleton, Mass. The following is a non-exclusive listing of exemplary styrene polymers that are, or that may be usable in the skin layers of the films of this invention:

Styrolux S, Styrene-Butadiene-Styrene block copolymer (S/B/S) with a specific gravity of 1.02 g/cm³, an MFR (200/5)=10 dg/min and a Vicat softening temperature of 72° C.

Styrolux T, styrene-butadiene block copolymer (SBC) with a specific gravity of 1.02 g/cm³, an MFR (200/5)=10 dg/min and a Vicat softening temperature of 67° C.

K-resin KR-52, a styrene-butadiene block copolymer (SBC) with a specific gravity of 1.01 g/cm³, an MFR (200/5)=9 dg/min and a Vicat softening temperature of 61° C. It is also available from Ineos Styrolution America, and can be used in place of Styrolux T, in combination with Styrolux S and Styrolux T, or can be used alone.

EA3400, is a general purpose polystyrene homopolymer with a specific gravity of 1.04 g/cm³, an MFR (200/5)=9 dg/min and a Vicat softening temperature of 99° C. This homopolymer is usable in combination with Styrolux T or K-resin KR-52 in the skin layer to provide a balance of stiffness and shrink performance. Preferably EA3400 is present in the range of from about 1% to about 70% by weight of the combination in the skin.

COC Blends

Topas 8007F-04 is a cyclic-olefin copolymer (COC). Topas 8007F-600 and 9506F-500 are cyclic-olefin copolymers (COC) incorporating a minor component of linear low density PE to reduce fracture of the brittle pellets during extrusion. The identified cyclic-olefin copolymers are copolymers of ethylene and norbornene polymerized with a metallocene catalyst. Since they are predominantly PE and metallocene catalyzed, they have nearly identical rheological behavior to mLLDPE. COC provides stiffness and promotes solvent seaming, as well as contributing to the shrink performance of the film. The 8007F grades from Topas have a density of 1.02 g/cc, a Tg of 78° C., and a melt index of 11 dg/min (230° C., 216 kg). The 9506F grades from Topas have a density of 1.02 g/cc, a Tg of 65° C. and a melt index of 5.4 dg/min (230° C., 216 kg). Other COC's are considered possibly to be useable in this invention, e.g., APEL8008T from Mitsui Chemical. Individuals skilled in the art can easily determine, without an undue amount of experimentation, COC's usable in this invention.

Styrene Block Copolymers (S-E/B-S and S-E/P)

Elastomeric Styrene block copolymers (SBC) with triblock styrene-ethylene-co-butene-styrene or styrene-ethylene-co-propylene-styrene or diblock styrene-ethylene-co-butene or styrene-ethylene-co-propylene structures which are used in the core layer of the films of this invention are commercially available from Kraton Corporation, Houston, Tex. or its distributor Univar Solutions, Downers Grove, Ill. Other Styrene block copolymers considered to be usable in this invention, and identified hereinafter, are commercially available from Kuraray Elastomer Division of Kuraray Americas, Inc., Houston, Tex. and Asahi Kasei, Tokyo, Japan, or its distributor Marubeni Specialty Chemicals Inc., White Plains, N.Y. The elastomeric styrene block copolymers are present in the core together with the Polypropylene terpolymer or copolymer, optionally the Propylene-based elastomer, and optionally the Polybutene-1 copolymer. The core can include one or more elastomeric styrene block copolymers in which the “rubbery block” composition is ethylene-butene or ethylene-propylene. These elastomeric materials have a specific gravity in the range of 0.89 to 0.93 g·cm³, a styrene content of 12 to 40%, and an ethylene-butene or ethylene-propylene copolymer content of 60-88%, by weight. The styrene block copolymer component of the core is an essential components, contributing to the shrink performance of the film, the excellent adhesion of the skin layers to the core, and the excellent optical properties of the transparent versions of the film, with and without the addition of reclaim into the core.

Suitable Kraton elastomeric styrene block copolymers include:

Kraton G1645: Styrene-ethylene-co-butene-Styrene triblock elastomer with 12.5% styrene content, MFR (230/2.16)=3.3 dg/min, and ethylene-co-butene block Tg=−42.

Kraton G1652: Styrene-ethylene-co-butene-Styrene triblock elastomer with 30% styrene content, MFR (230/2.16)=5 dg/min, and a specific gravity of 0.91 g/cm³.

Kraton G1643: Styrene-ethylene-co-butene-Styrene triblock elastomer with 20% styrene content, MFR (230/2.16)=19 dg/min, and a specific gravity of 0.90.

Kraton G1657: Styrene-ethylene-co-butene-Styrene triblock (70%)/Styrene-ethylene-co-butene diblock (30%) with 13% styrene content, MFR (230/5)=22, and a specific gravity of 0.90 g/cm³.

Kraton G1726: Styrene-ethylene-co-butene-Styrene triblock (30%)/Styrene-ethylene-co-butene diblock (70%) with 30% styrene content, MFR (190/2.16)=19, and a specific gravity of 0.91 g/cm³.

Kraton G1730: Styrene-ethylene-co-propylene-styrene-ethylene-co-propylene tetrablock elastomer with 21% styrene content, MFR (230/5)=13 dg/min, and a specific gravity of 0.90 g/cm³.

Kraton G1701: Styrene-ethylene-co-propylene diblock elastomer with 37% styrene content, MFR (230/5)=1 dg/min, and a specific gravity of 0.92 g/cm³.

Kraton G1702: Styrene-ethylene-co-propylene diblock elastomer with 28% styrene content, MFR (230/5)<1 dg/min, and a specific gravity of 0.91 g/cm³.

Elastomeric Styrene block copolymers (SBC) are also available from Kuraray Elastomer Division of Kuraray Americas, Inc., Houston, Tex. under the tradename SEPTON. Suitable SEPTON elastomer grades would include:

SEPTON 2063: Styrene—ethylene-co-propylene-Styrene triblock elastomer with 13% styrene content, MFR (230/2.16)=7 dg/min.

SEPTON 2004F: Styrene—ethylene-co-propylene-Styrene triblock elastomer with 18% styrene content, MFR (230/2.16)=5 dg/min

SEPTON 2002: Styrene—ethylene-co-propylene-Styrene triblock elastomer with 30% styrene content, MFR (230/2.16)=70 dg/min.

Elastomeric Styrene block copolymers (SBC) are also available from Asahi Kasei, Tokyo, Japan or its distributor Marubeni Specialty Chemicals Inc., White Plains, N.Y. under the tradename Tuftec.

Tuftec P1500 SEBS with a specific gravity=0.91 g/cm³, a PS content=30%, and a MFR (190/2.16)=4.0.

Polypropylene Terpolymers and Copolymers

Polypropylene terpolymers are commercially available from LyondellBasell, Houston, Tex. under the trade name Adsyl. The following is a non-exclusive listing of exemplary polypropylene terpolymers that are, or that may be usable in the core layers of the films in this invention:

LyondellBasell Adsyl 6C30F is a Ziegler-Natta catalyzed random terpolymers of propylene, ethylene, and butene with the propylene being the predominant component, by weight, of the terpolymer. Adsyl 6C30F has a MFR (230/2.16) of 5.5 dg/min, a SIT of 98° C., and a DSC peak melting point of 126° C.

Adsyl 7410XCP also is a terpolymer of propylene, ethylene and butene, with propylene being the predominant component, by weight, and which has a MFR (230/2.16) of 5.5 dg/min, a SIT of 75° C., and a DSC peak melting point of 125° C. and Adsyl 5C30F with a melt flow rate of 5.5 dg/min (230° C., 2.16 kg), a SIT of 105° C., and a DSC peak melting point of 132° C.

Polypropylene copolymers with ethylene or butene-1 as co-monomers are commercially available from a number of sources, including LyondellBasell in Houston, Tex., Ineos Olefins & Polymers USA headquartered in League City, Tex., Braskem America Inc. headquartered in Philadelphia, Pa. and Total USA headquartered in Houston, Tex. The following is a non-exclusive listing of exemplary polypropylene copolymers that are, or that may be usable in the core layers in the films of this invention:

Ineos Eltex P KS407 is a copolymer of propylene and about 4.0% ethylene, with propylene being the predominant component, by weight, and which has a MFR (230/2.16) of 5 dg/min, and a DSC peak melting point of 134° C.

Braskem DS6D82 is a copolymer of propylene and about 4.0% ethylene, with propylene being the predominant component, by weight, and which has a MFR (230/2.16) of 7 dg/min, and a DSC peak melting point of 134° C.

Total 8573 is a copolymer of propylene and ethylene with propylene being the predominant component, by weight; having a MFR (230/2.16) of 6.8 dg/min and having a DSC peak melting point of approximately 135° C.

LyondellBasell Adsyl 7416 XCP is a copolymer of propylene and ethylene with propylene being the predominant component, by weight; having a MFR (230/2.16) of 7.5 dg/min and having a DSC peak melting point of approximately 133° C.

LyondellBasell Adsyl 7415 XCP is a copolymer of propylene and ethylene with propylene being the predominant component, by weight, having a MFR (230/2.16) of 0.9 dg/min and having a DSC peak melting point of approximately 133° C.

LyondellBasell Adsyl 3C30F HP is a copolymer of propylene and butene-1 with the propylene being the predominant component, by weight, of the copolymer and which has a MFR (230/2.16) of 5.5 dg/min, and a DSC peak melting point of 137° C.

Polypropylene terpolymers and copolymers are primary components of the core and provide high clarity and are a contributing factor to high shrink performance within the temperature range requirement of heat shrink label applications (90-100° C.).

Polybutene-1 Copolymer

Polybutene-1 copolymers are commercially available from LyondellBasell, Houston, Tex. under the trade names Koattro and Toppyl. LyondellBasell Koattro DP8310M and Toppy1 DP8220M are Polybutene-1 copolymers with ethylene.

Koattro DP8310M has a MFR (190/2.16) of 3.5 dg/min, a melting point of 94° C., and a density of 0.897 g/cm³, and is characterized as having a high ethylene content. In this copolymer the ethylene content is less than 50% by weight thereof, and most preferably is less than 15% by weight.

Toppy1 DP8220M has a MFR (190/2.16) of 2.5 dg/min, a melting point of 97° C., and a density of 0.901 g/cc and is characterized as having a medium ethylene content. In this copolymer the ethylene content is less than 50% by weight, and most preferably is less than 15% by weight. This does have a lower ethylene content than Koattro DP8310M, identified above.

Polybutene-1 copolymer is an optional component of the core; contributing to the desired, high shrink performance within the temperature range requirement for heat shrink label applications (80-100° C.).

Vistamaxx and Versify Copolymers

Propylene-based polyolefin elastomers (POE's) are commercially available from ExxonMobil Chemical Company under the trade name Vistamaxx or Dow Chemical Company under the trade name Versify.

Composition and structure: These POE's are semi-crystalline copolymers of propylene and ethylene with high propylene levels (>80 wt. %) with isotactic stereochemistry. Crystallinity is modulated by the ethylene content to 5-45% crystallinity complementary to a large amorphous fraction. These POE's also have the following properties: a narrow Molecular Weight Distribution (MWD), a MFR (230/2.16) in the range of 2 to 25 g/10 min, a density in the range of 0.863 to 0.891 g/cm³, a Glass Transition Temperature Tg in the range of 5 to −31° F. (−15 to −35° C.) and a Melting Range: of 122 to 248° F. (50 to 120° C.) and higher.

Vistamaxx 3980FL: MFR (190/2.16) of 3.2 dg/min, ethylene content of 9%, density of 0.879 g/cm³, and Vicat softening point of 76.7° C.

Versify 3000: MFR (230/2.16) of 8 dg/min, density of 0.88 g/cm³, melting point of 108° C., crystallinity=44%, and Vicat softening point of 52° C.

The propylene based POE, like the polybutene-1 copolymer, is an optional component of the core layer; contributing to the desired, high shrink performance within the temperature range requirement for heat shrink label applications (80-100° C.).

White non-voiding opacifying pigments (TiO₂ concentrates): Pigment concentrates are commercially available from LyondellBasell, Houston, Tex. under the trade names Polybatch. Preferred are concentrates in a polyethylene carrier polymer. The following is a non-exclusive listing of exemplary TiO₂ concentrates that are, or that may be usable in the core layers of the films in this invention:

Polybatch White LL8006 CT, 70 wt. % TiO₂ in a 20 MILLDPE carrier. MFR of the concentrate (190° C., 2.16 kg is 6-11 g/10 min., and the concentrate is calcium stearate free.

Polybatch White 8000 EC, 70 wt. % TiO₂ in a 13 MILDPE carrier. MFR of the concentrate (190° C., 2.16 kg is 2-6 g/10 min., and the concentrate is calcium stearate free.

Processing

Manufacturing of the multilayer oriented shrink film according to this invention can be carried out on a typical tenter frame BOPP line, however, it requires process conditions that are different from those used for making other BOPP label or packaging films. So is the casted film is much thinner and sensitive to the exact width of the die lip gap, MD orientation is minimal (less than 1.4× at 80-90° C.), and TD orientation is fairly cold (7× to 8.5× at 90-108° C.). The essentially uniaxial TD-only oriented film is then wound up on a bobbin.

Manufacturing MD shrink films in accordance with this invention can be carried out in a manner known to those skilled in the art. For example, a multi-layer, relatively thick cast film is co-extruded through a flat film die. The cast film is then quenched or cooled on a chill roll or series of stacked casting rolls. The cooled cast film then is directed into a MD orientation unit where it traverses a series of heated rolls. The reheated cast film is then stretched or oriented up to 10 times or more on smaller diameter rolls rotating at progressively higher speeds. The essentially uniaxially, MD only oriented film is then wound up on a bobbin.

The invention will be illustrated in more detail with reference to the following Examples, but it should be understood that the present invention is not deemed to be limited thereto.

### EXAMPLES

### Comparative Example 1

Three films, identified as Comparative Example 1 as a group, were investigated. The films all contained skin layers with 85% Styrolux S and 15% Styrolux T with a core composition containing Kraton G1645 styrene-ethylene-butene-styrene triblock copolymer at a level of 40 wt. %. The films vary only in the overall film thickness and smaller variations in the skin thickness. Properties are provided in Tables 1 and Table 2 below.

TABLE 1

| Film | Unit of | Comparative Example 1. | | |
|---|---|---|---|---|
| Property | Measure | Three Layer Styrolux S/Styrolux T Skins | | |
| Skin | | 85% Styrolux S/15% Styrolux T | | |
| Composition | | | | |
| Core | | 40% Kraton G1645/40% Adsyl 6C30F/20% | | |
| Composition | | Vistamaxx 3980FL | | |
| Yield | in²/lb | 19,913 | 16,261 | 13,943 |
| Density | g/cm³ | 0.936 | 0.942 | 0.934 |
| Film Thickness | microns | 38 | 46 | 54 |
| (calculated) | | | | |
| Skin Thickness | microns | 8.1 | 8.8 | 10.2 |
| (measured) | | | | |
| Haze | % | 0.4 | 0.7 | 0.7 |
| 45° Gloss-IN | gu | >100 | >100 | >100 |
| 45° Gloss-OUT | gu | >100 | >100 | >100 |
| Gurley Stiffness | | 3.5/4.3 | 6.2/8.6 | 10.8/12.7 |
| MD/TD | | | | |
| Flex Stiffness | g/in | 1.8/2.0 | 3.0/3.7 | 4.9/8.1 |
| MD/TD | | | | |
| Z-axis Strength | g/in | 26 | 26 | 23 |

A core layer composition containing 40 wt. % Kraton G1645 Styrene-ethylene-co-butene-styrene (SEBS) block copolymer, 40 wt. % Adsyl 6C30F propylene-ethylene-butene random terpolymer and 20% Vistamaxx 3980FL propylene-ethylene elastomeric copolymer provides an excellent balance of film optics and stiffness. However, the interlaminar bond strength between the Styrenic blend skin layers and the core is unacceptably poor, as illustrated by a Z-axis strength of only 23-26 g/in.

TABLE 2

| Film | Unit of | Comparative Example 1. | | |
|---|---|---|---|---|
| Property | Measure | Three Layer Styrolux S/Styrolux T Skins | | |
| Skin | | 85% Styrolux S/15% Styrolux T | | |
| Composition | | | | |
| Core | | 40% Kraton G1645/40% Adsyl 6C30F/20% | | |
| Composition | | Vistamaxx 3980FL | | |
| TD Shrink | | | | |
| 65° C. | % | 5 | 2 | 2 |
| 70° C. | % | 20 | 18 | 18 |
| 75° C. | % | 35 | 34 | 33 |
| 80° C. | % | 46 | 44 | 42 |
| 85° C. | % | 55 | 55 | 53 |
| 90° C. | % | 62 | 60 | 59 |
| 95° C. | % | 65 | 65 | 66 |
| 100° C. | % | 71 | 70 | 68 |
| 105° C. | % | 74 | 73 | 70 |
| Shrink Tension | | | | |
| TD | | | | |
| 80° C. | grams | 248 | 261 | 276 |
| 85° C. | grams | 247 | 270 | 278 |
| 90° C. | grams | 276 | 278 | 275 |
| 95° C. | grams | 276 | 282 | 287 |
| 100° C. | grams | 279 | 312 | 290 |
| Natural Shrink | | | | |
| TD | | | | |
| 30° C. | % | −0.25 | 0.0 | 0.0 |
| 35° C. | % | 0.5 | 0.25 | 0.25 |

The combination of 40% wt. % styrene block copolymer, propylene terpolymer, and propylene elastomer in the core together with a blend of styrene-butadiene block copolymer in the skin layers provide a very attractive balance of shrink performance with low shrink tension. But the low Z-axis strength would make this structure unsuitably for solvent shrink sleeve applications.

The following describes a number of specific embodiments of this invention. One embodiment, identifying optional components in the core or base layer is depicted below.

Corona Treatment (optional)

| | |
|---|---|
| ~4-13 μm-skin layer | 65-100% Styrolux S/0-35% Styrolux T SBC |
| 20-45 μm-core layer | 45-65% Kraton G SEBS Block Copolymers |
| | 20-55% LYB Adsyl 6C30F Terpolymer |
| | 0-30% Vistamaxx 3980FL |
| | 0-10% LYB Koattro DP8310M Polybutene-1 |
| | copolymer |
| | 0-25% Simulated Reclaim |
| | 0-15% Polybatch White LL8006 CT or 8000 |
| | EC TiO₂ Concentrate |
| ~4-13 μm-skin layer | 65-100% Styrolux S/0-35% Styrolux T SBC |

Corona Treatment (optional)

### Example 1

Three additional films, identified as Example 1 as a group, were investigated. The films all contained skin layers with 85% Styrolux S and 15% Styrolux T with a core composition containing Kraton G1645 styrene-ethylene-butene-styrene triblock copolymer at a level of 55 wt. %. The films vary only in the overall film thickness and smaller variations in the skin thickness. Properties are provided in Tables 3 and Table 4 below. A density below 1 g/cm³ for floatability in a recycling operation and excellent optical properties as indicated by the very low haze and very high surface gloss are observed. The incorporation of a styrene-ethylene-co-butene-styrene triblock copolymer as the primary component at a level of ≥50 wt. %, together with a propylene terpolymer and propylene elastomer components provides with very strong adhesion between the skin and core layers as illustrated by the high level of Z-axis strength shown in Table 3.

TABLE 3

| Film | Unit of | Example 1. | | |
|---|---|---|---|---|
| Property | Measure | Three Layer Styrolux S/Styrolux T Skins | | |
| Skin | | 85% Styrolux S/15% Styrolux T | | |
| Composition | | | | |
| Core | | 55% Kraton G1645/27% Adsyl 6C30F/18% | | |
| Composition | | Vistamaxx3980FL | | |
| Yield | in²/lb | 16,722 | 16,192 | 15,490 |
| Density | g/cm³ | 0.933 | 0.931 | 0.933 |
| Film Thickness | microns | 45 | 47 | 49 |
| (calculated) | | | | |
| Skin Thickness | microns | 8.1 | 8.2 | 9.9 |
| (measured) | | | | |
| Haze | % | 1.3 | 1.2 | 1.0 |
| 45° Gloss-IN | gu | >100 | >100 | >100 |
| 45° Gloss-OUT | gu | >100 | >100 | >100 |
| Surface | Dynes | 56 | 56 | 57 |
| Treat (IN) | | | | |
| Surface | | 31 | 31 | 31 |
| Treat (OUT) | | | | |
| Gurley Stiffness | | 7.8/6.6 | 6.1/6.3 | 8.2/10.2 |
| MD/TD | | | | |
| Flex Stiffness | g/in | 2.7/3.0 | 2.9/3.4 | 3.1/3.5 |
| MD/TD | | | | |
| Z-axis Strength | g/in | 200 | 258 | 184 |

TABLE 4

| | Unit of | Example 1. Three Layer | | |
|---|---|---|---|---|
| Film Property | Measure | Styrolux S/Styrolux T Skins | | |
| Skin Composition | | 85% Styrolux S/15% Styrolux T | | |
| Core | | 55% Kraton G1645/27% Adsyl | | |
| Composition | | 6C30F/18% Vistamaxx 3980FL | | |
| TD Shrink | | | | |
| 65° C. | % | 13 | 33 | 11 |
| 70° C. | % | 28 | 26 | 26 |
| 75° C. | % | 44 | 43 | 43 |
| 80° C. | % | 52 | 52 | 51 |
| 85° C. | % | 59 | 58 | 58 |
| 90° C. | % | 64 | 64 | 64 |
| 95° C. | % | 69 | 69 | 69 |
| 100° C. | % | 69 | 70 | 71 |
| 105° C. | % | 72 | 73 | 73 |
| Shrink Tension TD | | | | |
| 80° C. | grams | 319 | 308 | 330 |
| 85° C. | grams | 284 | 310 | 311 |
| 90° C. | grams | 322 | 311 | 340 |
| 95° C. | grams | 284 | 310 | 310 |
| 100° C. | grams | 303 | 296 | 307 |
| Natural Shrink TD | | | | |
| 30° C. | % | 0.25 | 0.25 | 0.25 |
| 35° C. | % | 1.0 | 1.0 | 0.75 |

The use of styrene block copolymer as the predominant component of the core layer in combination with propylene terpolymer and propylene elastomer also provides an exceptional balance of shrink performance (69% at 95° C.) and moderate shrink tension as illustrated in Table 4 above. The moderate slope of TD shrink with increasing temperature and moderate shrink tension provides a more uniform shrink against the bottle or container which minimizes the potential for wrinkling of the label or entrapment of air pockets between the label and container. Low shrink tension is particularly desirable for less rigid containers with low wall thicknesses or operations in which the containers are labeled empty.

### Example 2

An additional film, identified as Example 2 was investigated. The film contained skin layers with 85% Styrolux S and 15% Styrolux T with a core composition containing Kraton G1645 styrene-ethylene-butene-styrene triblock copolymer at a level of 50 wt. % and Koattro DP8310M at a level of 5%. Properties are provided in Tables 5 and Table 6 below.

TABLE 5

| | Unit of | Example 2. Three Layer |
|---|---|---|
| Film Property | Measure | Styrolux S/Styrolux T Skins |
| Skin Composition | | 85% Styrolux S/15% Styrolux T |
| Core Composition | | 50% Kraton G1645/25% Adsyl 6C30F/5% |
| | | Koattro DP8310M/20% Vistamaxx 3980FL |
| Yield | in²/lb | 20,452 |
| Density | g/cm³ | 0.922 |
| Film Thickness | microns | 37 |
| (calculated) | | |
| Skin Thickness | microns | 7.2 |
| (measured) | | |
| Haze | % | 0.5 |
| 45° Gloss-IN | gu | >100 |
| 45° Gloss-OUT | gu | >100 |
| Gurley Stiffness | | 2.9/3.1 |
| MD/TD | | |
| Flex Stiffness | g/in | 1.4/1.8 |
| MD/TD | | |
| Z-axis Strength | g/in | 116 |

The introduction of a low level (5 wt. %) of the optional Polybutene-1 copolymer with ethylene component as a partial replacement for the combination of styrene block copolymer and propylene terpolymer provides a film with an excellent balance of optics (Haze<1%), interlayer strength (Z-axis>100 g/in), and as illustrated in Table 6 below, a very attractive balance of TD shrink performance, a further lowering of shrink tension, and good storage stability.

TABLE 6

| | Unitof | Example 2. Three Layer |
|---|---|---|
| Film Property | Measure | Styrolux S/Styrolux T Skins |
| Skin Composition | | 85% Styrolux S/15% Styrolux T |
| Core Composition | | 50% Kraton G1645/25% Adsyl 6C30F/5% |
| | | Koattro DP8310M/20% Vistamaxx 3980FL |
| TD Shrink | | |
| 65° C. | % | 4 |
| 70° C. | % | 20 |
| 75° C. | % | 40 |
| 80° C. | % | 50 |
| 85° C. | % | 59 |
| 90° C. | % | 65 |
| 95° C. | % | 69 |
| 100° C. | % | 72 |
| 105° C. | % | 74 |
| Shrink Tension TD | | |
| 80° C. | grams | 220 |
| 85° C. | grams | 209 |
| 90° C. | grams | 190 |
| 95° C. | grams | 223 |
| 100° C. | grams | 230 |
| Natural Shrink TD | | |
| 30° C. | % | 0.0 |
| 35° C. | % | 0.25 |

### Example 3

Two additional films, identified as Example 3 as a group, were investigated. The both films contained skin layers with 85% Styrolux S and 15% Styrolux T with a core composition containing Kraton G1645 styrene-ethylene-butene-styrene triblock copolymer at a level of 55 wt. %, Adsyl 6C30F propylene-ethylene-butene terpolymer at a level of 22.2 wt. %, and 6.8% Styrolux S and 1.2% Styrolux T to simulate the equivalent of 20% reclaim. The films vary only in the overall film thickness and smaller variations in the skin thickness. Properties are provided in Tables 7 and Table 8 below. The presence of >50 wt. % in the core, in combination with the propylene terpolymer and propylene-ethylene elastomer enables the incorporation of significant level of self-reclaim into the core while maintaining very good optics (haze<5%, gloss>100) while maintaining an exceptional level of adhesion between the skin and core layers. The ability to incorporate or “absorb” reclaim at such high levels without detrimental impact to the optical properties is very important in commercial oriented film production where off-spec film production and edge trim waste is typically on the order of 20% of production.

TABLE 7

| | Unit of | Example 3. Three Layer | |
|---|---|---|---|
| Film Property | Measure | Styrolux S/Styrolux T Skins | |
| Skin Composition | | 85% Styrolux S/15% Styrolux T | |
| Core Composition | | 55% Kraton G1645/22.2% Adsyl 6C30F/14.8% | |
| | | Vistamaxx 3980FL/6.8% Styrolux S/1.2% Styrolux T | |
| Yield | in²/lb | 15,096 | 14,039 |
| Density | g/cm³ | 0.938 | 0.939 |
| Film Thickness | microns | 50 | 53 |
| (calculated) | | | |
| Skin Thickness | microns | 6.0 | 8.9 |
| (measured) | | | |
| Haze | % | 2.9 | 3.6 |
| 45° Gloss-IN | gu | >100 | >100 |
| 45° Gloss-OUT | gu | >100 | >100 |
| Surface Treat (IN) | Dynes | 55 | 56 |
| Surface Treat (OUT) | | 31 | 31 |
| Gurley Stiffness | | 7.8/6.1 | 11.4/12.5 |
| MD/TD | | | |
| Flex Stiffness | g/in | 2.2/3.0 | 4.1/5.1 |
| MD/TD | | | |
| Z-axis Strength | g/in | 667 | 744 |

The incorporation of simulated reclaim into the core layer does not adversely affect the shrink performance of the film, as illustrated in Table 8 below.

TABLE 8

| | Unit of | Example 3. Three Layer | |
|---|---|---|---|
| Film Property | Measure | Styrolux S/Styrolux T Skins | |
| Skin Composition | | 85% Styrolux S/15% Styrolux T | |
| Core Composition | | 55% Kraton G1645/22.2% Adsyl 6C30F/14.8% Vistamaxx | |
| | | 3980FL/6.8% Styrolux S/1.2% Styrolux T | |
| TD Shrink | | | |
| 65° C. | % | 11 | 9 |
| 70° C. | % | 26 | 26 |
| 75° C. | % | 43 | 43 |
| 80° C. | % | 53 | 52 |
| 85° C. | % | 62 | 62 |
| 90° C. | % | 64 | 62 |
| 95° C. | % | 69 | 68 |
| 100° C. | % | 70 | 70 |
| 105° C. | % | 73 | 72 |
| Shrink Tension | | | |
| TD | | | |
| 80° C. | grams | 312 | 346 |
| 85° C. | grams | 310 | 326 |
| 90° C. | grams | 312 | 344 |
| 95° C. | grams | 310 | 326 |
| 100° C. | grams | 285 | 327 |
| Natural Shrink | | | |
| TD | | | |
| 30° C. | % | 0.5 | 0.25 |
| 35° C. | % | 1.0 | 1.0 |

### Example 4

Two additional films, identified as Example 4 as a group, were investigated. The films contained skin layers with 85% Styrolux S and 15% Styrolux T with a core composition containing Kraton G1645 styrene-ethylene-butene-styrene triblock copolymer at a level of 60 wt. % together with lesser and equivalent levels (20 wt. %) of both the propylene terpolymer and propylene-ethylene elastomer. The films vary only in the overall film thickness and smaller variations in the skin thickness. Properties are provided in Tables 9 and Table 10 below. Once again, a very attractive balance of density, optics, interlayer strength, and shrink performance is achieved with this higher level of styrene block copolymer in the core.

TABLE 9

| | Unit of | Example 4. Three Layer | |
|---|---|---|---|
| Film Property | Measure | Styrolux S/Styrolux T Skins | |
| Skin Composition | | 85% Styrolux S/15% Styrolux T | |
| Core Composition | | 60% Kraton G1645/20% Adsyl | |
| | | 6C30F/20% Vistamaxx 3980FL | |
| Yield | in²/lb | 17,552 | 15,605 |
| Density | g/cm³ | 0.937 | 0.937 |
| Film Thickness | microns | 43 | 48 |
| (calculated) | | | |
| Skin Thickness | microns | 7.3 | 7.9 |
| (measured) | | | |
| Haze | % | 0.6 | 0.5 |
| 45° Gloss-IN | gu | >100 | >100 |
| 45° Gloss-OUT | gu | >100 | >100 |
| Gurley Stiffness | | 4.8/8.3 | 6.8/7.3 |
| MD/TD | | | |
| Flex Stiffness | g/in | 2.6/2.7 | 3.0/3.3 |
| MD/TD | | | |
| Z-axis Strength | g/in | 214 | 523 |

TABLE 10

| | Unit of | Example 4. Three Layer | |
|---|---|---|---|
| Film Property | Measure | Styrolux S/Styrolux T Skins | |
| Skin Composition | | 85% Styrolux S/15% Styrolux T | |
| Core Composition | | 60% Kraton G1645/20% Adsyl | |
| | | 6C30F/20% Vistamaxx 3980FL | |
| TD Shrink | | | |
| 65° C. | % | 7 | 7 |
| 70° C. | % | 20 | 19 |
| 75° C. | % | 40 | 38 |
| 80° C. | % | 51 | 51 |
| 85° C. | % | 59 | 57 |
| 90° C. | % | 64 | 63 |
| 95° C. | % | 68 | 66 |
| 100° C. | % | 71 | 68 |
| 105° C. | % | 73 | 69 |
| Shrink Tension | | | |
| TD | | | |
| 80° C. | grams | 219 | 243 |
| 85° C. | grams | 243 | 211 |
| 90° C. | grams | 243 | 240 |
| 95° C. | grams | 234 | 232 |
| 100° C. | grams | 265 | 221 |
| Natural Shrink | | | |
| TD | | | |
| 30° C. | % | 0.0 | 0.0 |
| 35° C. | % | 0.25 | 0.25 |

In another embodiment, a propylene copolymer with a high level of ethylene is incorporated into the core layer in place of the propylene terpolymer component. Representative examples are described below.

Corona Treatment (optional)

| | | | |
|---|---|---|---|
| ~4-13 μm | skin layer | 65-100% | Styrolux S/0-35% Styrolux T SBC |
| 20-45 μm | core layer | 45-65% | Kraton G SEBS Block Copolymers |
| | | 20-55% | LYB Adsyl 7415 XCP Propylene-ethylene copolymer |
| | | 0-30% | Vistamaxx 3980FL propylene copolymer elastomer |
| | | 0-10% | LYB Koattro DP8310M Polybutene-1 copolymer |
| | | 0-25% | Simulated Reclaim |
| | | 0-15% | Polybatch White LL8006 CT or 8000 EC TiO2 Concentrate |
| -4-13 μm | skin layer | 65-100% | Styrolux S/0-35% Styrolux T SBC |

Corona Treatment (optional)

### Example 5

Three additional films, identified as Example 5 as a group, were investigated. The films all contained skin layers with 85% Styrolux S and 15% Styrolux T with a core composition containing Kraton G1643 styrene-ethylene-butene-styrene triblock copolymer at a level of 50 wt. % and Adsyl 7415XCP fractional melt flow high ethylene copolymer replacing the terpolymer at 30 wt. %. The films vary only in the overall film thickness and smaller variations in the skin thickness. Properties are provided in Tables 11 and Table 12 below.

TABLE 11

| | Unit of | Example 5. Three Layer Styrolux | | |
|---|---|---|---|---|
| Film Property | Measure | S/Styrolux T Skins | | |
| Skin Composition | | 85% Styrolux S/15% Styrolux T | | |
| Core Composition | | 50% Kraton G1643/30% Adsyl 7415 | | |
| | | XCP/20% Vistamaxx 3980FL | | |
| Yield | in²/lb | 17,253 | 15,958 | 14,947 |
| Density | g/cm³ | 0.934 | 0.949 | 0.937 |
| Film Thickness | microns | 44 | 46 | 50 |
| (calculated) | | | | |
| Skin Thickness | microns | 8.7 | 8.6 | 8.8 |
| (measured) | | | | |
| Haze | % | 1.3 | 1.3 | 2.4 |
| 45° Gloss-IN | gu | >100 | >100 | >100 |
| 45° Gloss-OUT | gu | >100 | >100 | >100 |
| Gurley Stiffness | | 5.2/6.9 | 5.4/10.6 | 8.4/10.6 |
| MD/TD | | | | |
| Flex Stiffness | g/in | 2.4/3.5 | 3.7/3.6 | 4.1/4.4 |
| MD/TD | | | | |
| Z-axis Strength | g/in | 159 | 195 | 154 |

Very low haze and high gloss together with a high level of interlayer adhesion as determined by Z-axis strength is achieved. Some improvement in film stiffness is observed. The shrink performance is suitable for the shrink sleeve market with a TD shrink>55% at 95° C. but is slightly lower than the level observed with the terpolymer component.

TABLE 12

| | Unit of | Example 5. Three Layer Styrolux | | |
|---|---|---|---|---|
| Film Property | Measure | S/Styrolux T Skins | | |
| Skin Composition | | 85% Styrolux S/15% Styrolux T | | |
| Core Composition | | 50% Kraton G1643/30% Adsyl 7415 | | |
| | | XCP/20% Vistamaxx 3980FL | | |
| TD Shrink | | | | |
| 65° C. | % | 4 | 4 | 4 |
| 70° C. | % | 19 | 20 | 20 |
| 75° C. | % | 29 | 29 | 33 |
| 80° C. | % | 36 | 35 | 37 |
| 85° C. | % | 42 | 42 | 43 |
| 90° C. | % | 49 | 49 | 49 |
| 95° C. | % | 56 | 56 | 56 |
| 100° C. | % | 62 | 62 | 62 |
| 105° C. | % | 66 | 66 | 66 |
| Shrink Tension | | | | |
| TD | | | | |
| 80° C. | grams | 233 | 223 | 243 |
| 85° C. | grams | 230 | 221 | 242 |
| 90° C. | grams | 248 | 257 | 259 |
| 95° C. | grams | 239 | 240 | 243 |
| 100° C. | grams | 245 | 239 | 254 |
| Natural Shrink | | | | |
| TD | | | | |
| 30° C. | % | 0.0 | 0.0 | 0.0 |
| 35° C. | % | 0.25 | 0.25 | 0.0 |

### Example 6

Three additional films, identified as Example 6 as a group, were investigated. The films all contained skin layers with 85% Styrolux S and 15% Styrolux T with a core composition containing Kraton G1643 styrene-ethylene-butene-styrene triblock copolymer at a level of 50 wt. %, Adsyl 7415XCP fractional melt flow high ethylene copolymer replacing the terpolymer at 25 wt. % and Koattro DP8310M at a level of 5%. The films vary only in the overall film thickness and smaller variations in the skin thickness. Properties are provided in Tables 13 and Table 14 below.

TABLE 13

| | Unit of | Example 6. Three Layer Styrolux | | |
|---|---|---|---|---|
| Film Property | Measure | S/Styrolux T Skins | | |
| Skin Composition | | 85% Styrolux S/15% Styrolux T | | |
| Core Composition | | 50% Kraton G1643/25% Adsyl | | |
| | | 7415 XCP/5% Koattro | | |
| | | DP8310M/20% Vistamaxx 3980FL | | |
| Yield | in²/lb | 17,372 | 16,611 | 15,791 |
| Density | g/cm³ | 0.934 | 0.939 | 0.936 |
| Film Thickness | microns | 43 | 45 | 48 |
| (calculated) | | | | |
| Skin Thickness | microns | 6.7 | 8.3 | 7.3 |
| (measured) | | | | |
| Haze | % | 1.2 | 2.0 | 1.1 |
| 45° Gloss-IN | gu | >100 | >100 | >100 |
| 45° Gloss-OUT | gu | >100 | >100 | >100 |
| Gurley Stiffness | | 4.8/7.0 | 7.1/9.5 | 8.4/9.1 |
| MD/TD | | | | |
| Flex Stiffness | g/in | 2.3/2.7 | 3.6/4.7 | 3.6/4.3 |
| MD/TD | | | | |
| Z-axis Strength | g/in | 137 | 147 | 106 |

The introduction of low levels (5 wt. %) of Polybutene-1 copolymer with ethylene as a partially replacing the high ethylene copolymer maintains the attractive balance of optics, stiffness, and Z-axis strength as illustrated in Table 13 above, while also improving the TD shrink performance of the film (˜65% at 95° C.) as illustrated in Table 15, relative to Example 5 without the low level addition of Polybutene-1 copolymer.

TABLE 14

| | Unit of | Example 6. Three Layer Styrolux | | |
|---|---|---|---|---|
| Film Property | Measure | S/Styrolux T Skins | | |
| Skin Composition | | 85% Styrolux S/15% Styrolux T | | |
| Core Composition | | 50% Kraton G1643/25% Adsyl | | |
| | | 7415 XCP/5% Koattro | | |
| | | DP8310M/20% Vistamaxx 3980FL | | |
| TD Shrink | | | | |
| 65° C. | % | 4 | 5 | 5 |
| 70° C. | % | 21 | 21 | 21 |
| 75° C. | % | 39 | 39 | 39 |
| 80° C. | % | 49 | 48 | 49 |
| 85° C. | % | 53 | 55 | 55 |
| 90° C. | % | 59 | 60 | 59 |
| 95° C. | % | 64 | 65 | 64 |
| 100° C. | % | 68 | 66 | 68 |
| 105° C. | % | 71 | 71 | 71 |
| Shrink Tension | | | | |
| TD | | | | |
| 80° C. | grams | 282 | 288 | 305 |
| 85° C. | grams | 266 | 266 | 288 |
| 90° C. | grams | 271 | 284 | 256 |
| 95° C. | grams | 274 | 268 | 254 |
| 100° C. | grams | 278 | 278 | 286 |
| Natural Shrink | | | | |
| TD | | | | |
| 30° C. | % | 0.0 | 0.0 | 0.0 |
| 35° C. | % | 0.25 | 0.25 | 0.25 |

### Example 7

Three additional films, identified as Example 7 as a group, were investigated. The films all contained skin layers with 85% Styrolux S and 15% Styrolux T with a core composition containing Kraton G1643 styrene-ethylene-butene-styrene triblock copolymer at a level of 55 wt. % and Adsyl 7415XCP fractional melt flow high ethylene copolymer replacing the terpolymer at 27 wt. %. The films vary only in the overall film thickness and smaller variations in the skin thickness. Properties are provided in Tables 15 and Table 16 below. A further increase in styrene-ethylene-co-butene-styrene block copolymer content to 55 wt. % in the core (as compared to 50 wt. % in example 5 and 6) generates a substantial improvement in interlayer adhesion as measured by Z-axis strength. This small increase also contributes to improvement in the shrink performance of the film at 95° C., as illustrated in Table 16.

TABLE 15

| | Unit of | Example 7. Three Layer Styrolux | | |
|---|---|---|---|---|
| Film Property | Measure | S/Styrolux T Skins | | |
| Skin Composition | | 85% Styrolux S/15% Styrolux T | | |
| Core Composition | | 55% Kraton G1643/27% Adsyl 7415 | | |
| | | XCP/18% Vistamaxx 3980FL | | |
| Yield | in²/lb | 17,681 | 17,500 | 17,806 |
| Density | g/cm³ | 0.941 | 0.939 | 0.942 |
| Film Thickness | microns | 42 | 43 | 42 |
| (calculated) | | | | |
| Skin Thickness | microns | 8.2 | 8.8 | 8.9 |
| (measured) | | | | |
| Haze | % | 2.6 | 2.4 | 2.2 |
| 45° Gloss-IN | gu | 97 | 99 | >100 |
| 45° Gloss-OUT | gu | 95 | >100 | 99 |
| Surface Treat (IN) | Dynes | 31 | 32 | 32 |
| Surface Treat (OUT) | | 42 | 45 | 49 |
| Gurley Stiffness | | 4.9/6.9 | 4.8/7.1 | 5.2/7.0 |
| MD/TD | | | | |
| Flex Stiffness | g/in | 2.3/2.6 | 2.3/2.9 | 1.9/2.3 |
| MD/TD | | | | |
| Z-axis Strength | g/in | 630 | 645 | 355 |

TABLE 16

| | Unit of | Example 7. Three Layer Styrolux | | |
|---|---|---|---|---|
| Film Property | Measure | S/Styrolux T Skins | | |
| Skin Composition | | 85% Styrolux S/15% Styrolux T | | |
| Core Composition | | 55% Kraton G1643/27% Adsyl 7415 | | |
| | | XCP/18% Vistamaxx 3980FL | | |
| TD Shrink | | | | |
| 65° C. | % | 10 | 10 | 10 |
| 70° C. | % | 23 | 23 | 24 |
| 75° C. | % | 38 | 35 | 36 |
| 80° C. | % | 46 | 42 | 44 |
| 85° C. | % | 52 | 50 | 50 |
| 90° C. | % | 57 | 55 | 55 |
| 95° C. | % | 63 | 60 | 61 |
| 100° C. | % | 66 | 63 | 64 |
| 105° C. | % | 68 | 66 | 67 |
| Shrink Tension | | | | |
| TD | | | | |
| 80° C. | grams | 271 | 256 | 289 |
| 85° C. | grams | 282 | 288 | 300 |
| 90° C. | grams | 275 | 241 | 281 |
| 95° C. | grams | 276 | 278 | 288 |
| 100° C. | grams | 278 | 276 | 284 |
| Natural Shrink | | | | |
| TD | | | | |
| 30° C. | % | 1.0 | 1.0 | 1.0 |
| 35° C. | % | 1.0 | 1.0 | 1.0 |

### Example 8

An additional film, identified as Example 8, was investigated. The film contained skin layers with 85% Styrolux S and 15% Styrolux T with a core composition containing Kraton G1645 styrene-ethylene-butene-styrene triblock copolymer at a level of 55 wt. % and Adsyl 7415XCP fractional melt flow high ethylene copolymer replacing the terpolymer at 27 wt. %. Properties are provided in Tables 17 and Table 18 below. In comparison to Kraton G1643 which has a polystyrene block composition of 20 wt. % and a melt flow rate of 19 g/10 min at 230° C., Kraton G1645 has a polystyrene block composition of 12 wt. % and a melt flow rate of 3 g/10 min at 230° C. They both perform well in combination with the high ethylene copolymer and propylene elastomer, however, the lower styrene block content of the Kraton G1645 material provide an improvement in shrink performance at 95° C. (Table 18) and a lower but still acceptable level of Z-axis strength (Table 17). Shrink tension also appears to be higher with the lower melt flow rate and lower styrene content G1645 present in the formulation as compared to the film structure containing G1643 as the styrene block copolymer in the core.

TABLE 17

| | Unit of | Example 8. Three Layer Styrolux |
|---|---|---|
| Film Property | Measure | S/Styrolux T Skins |
| Skin Composition | | 85% Styrolux S/15% Styrolux T |
| Core Composition | | 55% Kraton G1645/27% Adsyl 7415 |
| | | XCP/18% Vistamaxx 3980FL |
| Yield | in²/lb | 15,259 |
| Density | g/cm³ | 0.933 |
| Film Thickness | microns | 49 |
| (calculated) | | |
| Skin Thickness (measured) | microns | 7.3 |
| Haze | % | 1.8 |
| 45° Gloss-IN | gu | >100 |
| 45° Gloss-OUT | gu | >100 |
| Surface Treat (IN) | Dynes | 57 |
| Surface Treat (OUT) | | 31 |
| Gurley Stiffness | | 9.7/9.8 |
| MD/TD | | |
| Flex Stiffness | g/in | 3.1/3.6 |
| MD/TD | | |
| Z-axis Strength | g/in | 126 |

TABLE 18

| | Unit of | Example 8. Three Layer |
|---|---|---|
| Film Property | Measure | Styrolux S/Styrolux T Skins |
| Skin Composition | | 85% Styrolux S/15% Styrolux T |
| Core Composition | | 55% Kraton G1645/27% Adsyl 7415 |
| | | XCP/18% Vistamaxx 3980FL |
| TD Shrink | | |
| 65° C. | % | 16 |
| 70° C. | % | 26 |
| 75° C. | % | 45 |
| 80° C. | % | 51 |
| 85° C. | % | 58 |
| 90° C. | % | 62 |
| 95° C. | % | 67 |
| 100° C. | % | 70 |
| 105° C. | % | 72 |
| Shrink Tension TD | | |
| 80° C. | grams | 398 |
| 85° C. | grams | 439 |
| 90° C. | grams | 398 |
| 95° C. | grams | 439 |
| 100° C. | grams | 447 |
| Natural Shrink TD | | |
| 30° C. | % | 0.5 |
| 35° C. | % | 1.0 |

### Example 9

Three additional films, identified as Example 9 as a group, were investigated. The films all contained skin layers with 85% Styrolux S and 15% Styrolux T with a core composition containing Kraton G1643 styrene-ethylene-butene-styrene triblock copolymer at a level of 55 wt. %, Adsyl 7415XCP fractional melt flow rate high ethylene copolymer at a level of 22.2 wt. %, and 6.8% Styrolux S and 1.2% Styrolux T to simulate the equivalent of 20% reclaim. The films vary only in the overall film thickness and smaller variations in the skin thickness. Properties are provided in Tables 19 and Table 20 below. Similar to prior observations in Example 3, the presence of >50 wt. % styrene block copolymer in the core, in this example in combination with the high ethylene copolymer and propylene-ethylene elastomer enables the incorporation of significant level of self-reclaim into the core while maintaining very good optics (haze≤2.5%, gloss>100) while maintaining an exceptional level of adhesion between the skin and core layers. The ability to incorporate or “absorb” reclaim at such high levels without detrimental impact to the optical properties is very important in commercial oriented film production where off-spec film production and edge trim waste is typically on the order of 20% of production.

TABLE 19

| | Unit of | | | |
|---|---|---|---|---|
| Film Property | Measure | Example 9. Three Layer Styrolux S/Styrolux T Skins | | |
| Skin Composition | | 85% Styrolux S/15% Styrolux T | | |
| Core Composition | | 55% Kraton G1643/22.2% Adsyl 7415 XCP/14.8% | | |
| | | Vistamaxx 3980FL/6.8% Styrolux S/1.2% Styrolux T | | |
| Yield | in²/lb | 19,740 | 19,335 | 18,704 |
| Density | g/cm³ | 0.946 | 0.948 | 0.945 |
| Film Thickness | microns | 38 | 38 | 40 |
| (calculated) | | | | |
| Skin Thickness | microns | 7.6 | 6.5 | 7.4 |
| (measured) | | | | |
| Haze | % | 2.3 | 2.0 | 2.0 |
| 45°Gloss - IN | gu | 94 | >100 | >100 |
| 45° Gloss - OUT | gu | >100 | >100 | >100 |
| Surface Treat (IN) | Dynes | 33 | 36 | 35 |
| Surface Treat (OUT) | | 51 | 52 | 52 |
| Gurley Stiffness | | 4.6/5.9 | 4.1/5.7 | 4.7/6.3 |
| MD/TD | | | | |
| Flex Stiffness | g/in | 1.8/2.0 | 1.5/1.9 | 1.7/2.2 |
| MD/TD | | | | |
| Z-axis Strength | g/in | 265 | 309 | 213 |

An attractive balance of TD shrink performance and low shrink tension is achieved with this film formulation, as illustrated in Table 20 below.

TABLE 20

| | Unit of | | | |
|---|---|---|---|---|
| Film Property | Measure | Example 9. Three Layer Styrolux S/Styrolux T Skins | | |
| Skin Composition | | 85% Styrolux S/15% Styrolux T | | |
| Core Composition | | 55% Kraton G1643/22.2% Adsyl 7415 XCP/14.8% | | |
| | | Vistamaxx 3980FL/6.8% Styrolux S/1.2% Styrolux T | | |
| TD Shrink | | | | |
| 65° C. | % | 11 | 12 | 12 |
| 70° C. | % | 25 | 25 | 25 |
| 75° C. | % | 37 | 37 | 38 |
| 80° C. | % | 47 | 47 | 47 |
| 85° C. | % | 53 | 53 | 54 |
| 90° C. | % | 59 | 59 | 59 |
| 95° C. | % | 65 | 64 | 64 |
| 100° C. | % | 67 | 68 | 69 |
| 105° C. | % | 71 | 71 | 71 |
| Shrink Tension TD | | | | |
| 80° C. | grams | 252 | 246 | 279 |
| 85° C. | grams | 272 | 254 | 273 |
| 90° C. | grams | 256 | 262 | 255 |
| 95° C. | grams | 261 | 264 | 265 |
| 100° C. | grams | 270 | 256 | 279 |
| Natural Shrink TD | | | | |
| 30° C. | % | 1.0 | 1.0 | 1.0 |
| 35° C. | % | 1.0 | 1.0 | 1.0 |

### Example 10

Three additional films, identified as Example 10 as a group, were investigated. The films all contained skin layers with 85% Styrolux S and 15% Styrolux T with a core composition containing a combination of Kraton G1643 and Kraton G1645 styrene-ethylene-butene-styrene triblock copolymer at a level of 27.5 wt. % for each, Adsyl 7415XCP fractional melt flow rate high ethylene copolymer at a level of 22.2 wt. %, and 6.8% Styrolux S and 1.2% Styrolux T to simulate the equivalent of 20% reclaim. The films vary only in the overall film thickness and smaller variations in the skin thickness. Properties are provided in Tables 21 and Table 22 below. A very attractive balance of properties can be achieved with a combination of styrene block copolymers in the core, one with a high styrene block content and high melt flow rate and a second with lower styrene lock content and a lower melt flow rate. This example illustrates the performance of the film with a simulated level of reclaim of 20 wt. %, demonstrating a “floatable” density, very attractive optical properties, good stiffness and z-axis performance, and a very attractive level of shrink performance, as shown in Tables 21 and 22.

TABLE 21

| | Unit of | | | |
|---|---|---|---|---|
| Film Property | Measure | Example 10. Three Layer Styrolux S/Styrolux T Skins | | |
| Skin Composition | | 85% Styrolux S/15% Styrolux T | | |
| Core Composition | | 27.5% Kraton G1643/27.5% Kraton G1645/22.2% | | |
| | | Adsyl 7415 XCP/14.8% Vistamaxx 3980FL/6.8% | | |
| | | Styrolux S/1.2% Styrolux T | | |
| Yield | in²/lb | 18,056 | 16,451 | 13,628 |
| Density | g/cm³ | 0.942 | 0.938 | 0.937 |
| Film Thickness | microns | 41 | 46 | 55 |
| (calculated) | | | | |
| Skin Thickness | microns | 7.5 | 8.6 | 9.0 |
| (measured) | | | | |
| Haze | % | 1.8 | 1.8 | 2.1 |
| 45° Gloss - IN | gu | >100 | >100 | >100 |
| 45° Gloss - OUT | gu | >100 | >100 | >100 |
| Surface Treat (IN) | Dynes | 31 | 32 | 33 |
| Surface Treat (OUT) | | 55 | 55 | 56 |
| Gurley Stiffness | | 7.4/8.4 | 6.9/9.1 | 10.0/13.2 |
| MD/TD | | | | |
| Flex Stiffness | g/in | 2.3/2.5 | 2.6/3.2 | 3.9/4.6 |
| MD/TD | | | | |
| Z-axis Strength | g/in | 293 | 213 | 242 |

TABLE 22

| | Unit of | | | |
|---|---|---|---|---|
| Film Property | Measure | Example 10. Three Layer Styrolux S/Styrolux T Skins | | |
| Skin Composition | | 85% Styrolux S/15% Styrolux T | | |
| Core Composition | | 27.5% Kraton G1643/27.5% Kraton G1645/22.2% Adsyl 7415 | | |
| | | XCP/14.8% Vistamaxx 3980FL/6.8% Styrolux S/1.2% Styrolux T | | |
| TD Shrink | | | | |
| 65° C. | % | 11 | 10 | 9 |
| 70° C. | % | 27 | 27 | 25 |
| 75° C. | % | 41 | 40 | 40 |
| 80° C. | % | 50 | 50 | 50 |
| 85° C. | % | 57 | 57 | 56 |
| 90° C. | % | 62 | 62 | 62 |
| 95° C. | % | 66 | 66 | 65 |
| 100° C. | % | 70 | 71 | 70 |
| 105° C. | % | 71 | 72 | 71 |
| Shrink Tension TD | | | | |
| 80° C. | grams | 323 | 357 | 359 |
| 85° C. | grams | 327 | 335 | 250 |
| 90° C. | grams | 333 | 334 | 357 |
| 95° C. | grams | 364 | 351 | 356 |
| 100° C. | grams | 348 | 355 | 368 |
| Natural Shrink TD | | | | |
| 30° C. | % | 1.5 | 1.5 | 1.5 |
| 35° C. | % | 1.5 | 1.5 | 1.5 |

### Example 11

Three additional films, identified as Example 11 as a group, were investigated. The films all contained skin layers with 85% Styrolux S and 15% Styrolux T with a core composition containing Kraton G1645 styrene-ethylene-butene-styrene triblock copolymer at a level of 55 wt. %, Adsyl 7415XCP fractional melt flow rate high ethylene copolymer at a level of 22.2 wt. %, and 6.8% Styrolux S and 1.2% Styrolux T to simulate the equivalent of 20% reclaim. The films vary only in the overall film thickness and smaller variations in the skin thickness. Properties are provided in Tables 23 and Table 24 below. This example further reinforces the beneficial effects of having >50 wt. % styrene block copolymer in the core, in this example the low melt flow and low styrene block content G1645 in combination with the high ethylene copolymer and propylene-ethylene elastomer. The core formulation enables the incorporation of significant level of self-reclaim into the core while maintaining very good optics (haze<5%, gloss>100) while maintaining an exceptional level of adhesion between the skin and core layers. The ability to incorporate or “absorb” reclaim at such high levels without detrimental impact to the optical properties is very important in commercial oriented film production where off-spec film production and edge trim waste is typically on the order of 20% of production.

TABLE 23

| | Unit of | | | |
|---|---|---|---|---|
| Film Property | Measure | Example 11. Three Layer Styrolux S/Styrolux T Skins | | |
| Skin Composition | | 85% Styrolux S/15% Styrolux T | | |
| Core Composition | | 55% Kraton G1645/22.2% Adsyl 7415 XCP/14.8% | | |
| | | Vistamaxx 3980FL/6.8% Styrolux S/1.2% Styrolux T | | |
| Yield | in²/lb | 17,198 | 16,644 | 12,410 |
| Density | g/cm³ | 0.938 | 0.940 | 0.931 |
| Film Thickness | microns | 44 | 45 | 61 |
| (calculated) | | | | |
| Skin Thickness | microns | 7.1 | 8.0 | 9.5 |
| (measured) | | | | |
| Haze | % | 2.8 | 3.5 | 4.4 |
| 45° Gloss - IN | gu | >100 | >100 | >100 |
| 45° Gloss - OUT | gu | >100 | >100 | >100 |
| Surface Treat (IN) | Dynes | 33 | 31 | 31 |
| Surface Treat (OUT) | | 42 | 48 | 47 |
| Gurley Stiffness | | 4.5/6.5 | 9.8/10.2 | 11.6/15.4 |
| MD/TD | | | | |
| Flex Stiffness | g/in | 2.1/2.4 | 2.6/3.1 | 6.2/6.5 |
| MD/TD | | | | |
| Z-axis Strength | g/in | 313 | 282 | 462 |

The lower styrene block content of the material provides an attractive balance of shrink performance with reduced level of shrink tension, particularly beneficial for thinner container walls and labeling of empty containers.

TABLE 24

| | Unit of | | | |
|---|---|---|---|---|
| Film Property | Measure | Example 11. Three Layer Styrolux S/Styrolux T Skins | | |
| Skin Composition | | 85% Styrolux S/15% Styrolux T | | |
| Core Composition | | 55% Kraton G1645/22.2% Adsyl 7415 XCP/14.8% | | |
| | | Vistamaxx 3980FL/6.8% Styrolux S/1.2% Styrolux T | | |
| TD Shrink | | | | |
| 65° C. | % | 12 | 11 | 8 |
| 70° C. | % | 26 | 26 | 22 |
| 75° C. | % | 41 | 40 | 38 |
| 80° C. | % | 51 | 50 | 48 |
| 85° C. | % | 58 | 57 | 55 |
| 90° C. | % | 63 | 63 | 61 |
| 95° C. | % | 67 | 66 | 64 |
| 100° C. | % | 70 | 70 | 68 |
| 105° C. | % | 73 | 73 | 70 |
| Shrink Tension TD | | | | |
| 80° C. | grams | 294 | 286 | 289 |
| 85° C. | grams | 273 | 275 | 289 |
| 90° C. | grams | 291 | 291 | 295 |
| 95° C. | grams | 290 | 291 | 301 |
| 100° C. | grams | 289 | 306 | 263 |
| Natural Shrink TD | | | | |
| 30° C. | % | 1.0 | 1.0 | 1.0 |
| 35° C. | % | 1.0 | 1.0 | 1.0 |

### Example 12

Three additional films, identified as Example 12 as a group, were investigated. The films all contained skin layers with 85% Styrolux S and 15% Styrolux T with a core composition containing Kraton G1643 styrene-ethylene-butene-styrene triblock copolymer at a level of 45 wt. %, Adsyl 7415XCP fractional melt flow rate high ethylene copolymer at a level of 30 wt. %, and 5% Styrolux S to simulate the equivalent of 15% reclaim, and 5% Polybatch White 8000 EC TiO₂ masterbatch (70% in LLDPE). The films vary only in the overall film thickness and smaller variations in the skin thickness. Properties are provided in Tables 25 and Table 26 below. Opaque solid white film with a moderate level of opacity, good interlayer strength, and a very attractive balance of shrink performance, low shrink tension, and good storage temperature stability while maintaining a density significantly below 1 g/cm³ is achieved with the introduction of both reclaim (simulated) and a low level of TiO₂ (3.5 wt. %).

TABLE 25

| | Unit of | | | |
|---|---|---|---|---|
| Film Property | Measure | Example 12. Three Layer Styrolux S/Styrolux T Skins | | |
| Skin Composition | | 85% Styrolux S/15% Styrolux T | | |
| Core Composition | | 45% Kraton G1643/30% Adsyl 7415 XCP/15% Vistamaxx | | |
| | | 3980FL/5% Styrolux S/5% Polybatch White 8000 EC | | |
| Yield | in²/lb | 18,071 | 16,739 | 16,470 |
| Density | g/cm³ | 0.956 | 0.958 | 0.957 |
| Film Thickness | microns | 41 | 44 | 45 |
| (calculated) | | | | |
| Skin Thickness | microns | 7.7 | 6.8 | 9.4 |
| (measured) | | | | |
| Opacity | % | 50 | 54 | 54 |
| 45° Gloss - IN | gu | 64 | 64 | 65 |
| 45° Gloss - OUT | gu | 63 | 63 | 65 |
| Gurley Stiffness | | 4.3/7.2 | 4.9/5.4 | 6.2/7.7 |
| MD/TD | | | | |
| Flex Stiffness | g/in | 3.4/3.6 | —/3.5 | 2.4/2.5 |
| MD/TD | | | | |
| Z-axis Strength | g/in | 119 | 123 | 157 |

TABLE 26

| | Unit of | | | |
|---|---|---|---|---|
| Film Property | Measure | Example 12. Three Layer Styrolux S/Styrolux T Skins | | |
| Skin Composition | | 85% Styrolux S/15% Styrolux T | | |
| Core Composition | | 45% Kraton G1643/30% Adsyl 7415 XCP/15% Vistamaxx | | |
| | | 3980FL/5% Styrolux S/5% Polybatch White 8000 EC | | |
| TD Shrink | | | | |
| 65° C. | % | 6 | 6 | 5 |
| 70° C. | % | 23 | 24 | 23 |
| 75° C. | % | 35 | 35 | 34 |
| 80° C. | % | 49 | 50 | 50 |
| 85° C. | % | 50 | 51 | 50 |
| 90° C. | % | 58 | 58 | 58 |
| 95° C. | % | 63 | 62 | 63 |
| 100° C. | % | 66 | 65 | 66 |
| 105° C. | % | 69 | 68 | 69 |
| Shrink Tension TD | | | | |
| 80° C. | grams | 315 | 307 | — |
| 85° C. | grams | 325 | 309 | — |
| 90° C. | grams | 337 | 344 | — |
| 95° C. | grams | 335 | 291 | — |
| 100° C. | grams | 320 | 311 | — |
| Natural Shrink TD | | | | |
| 30° C. | % | 0 | 0 | 0 |
| 35° C. | % | 0.25 | 0.25 | — |

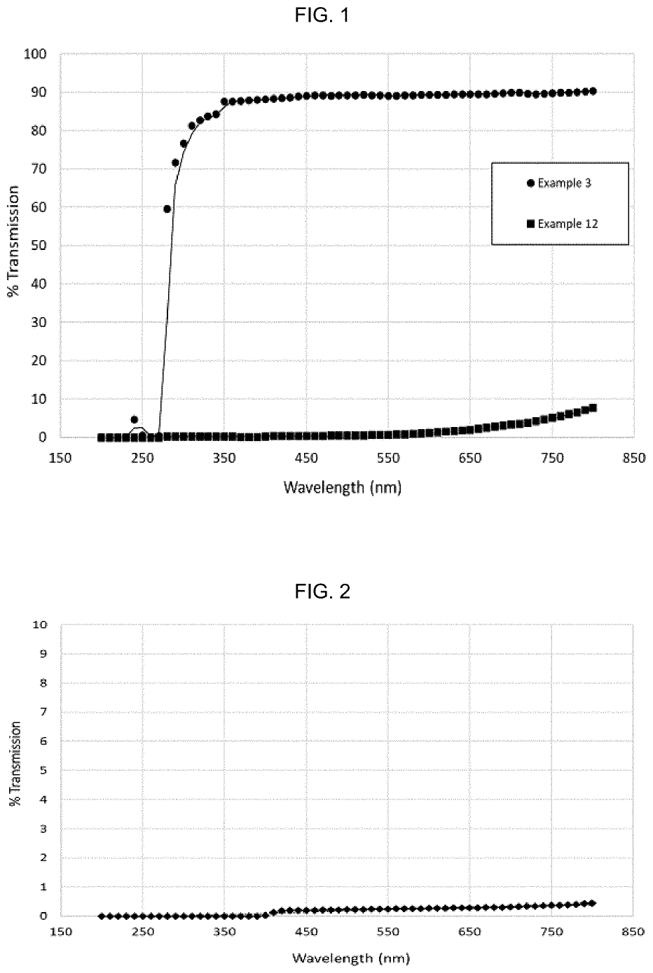

The introduction of reclaim and an opacifying agent into the core while maintaining a density below 1 g/cm³ provides the ability to produce a floatable film which can be separated from non-floatable containers while creating an effective UV and Visible light barrier in applications, such as dairy products, where the container contents are detrimentally affected over time by light exposure in the wavelength range of 200-750 nm. This is illustrated in FIG. 1 below which compares the light blocking performance (% Transmission) of optically clear film of Example 3 as compared to Example 12, which contains 3.5% by weight TiO₂ in the core. Exceptional light blocking performance (below 5% transmission in the range of 200-750 nm wavelength) with the incorporation of film reclaim and the introduction of low levels of opacifying agents is demonstrated.

In another embodiment, a blend of cyclic olefin copolymers are used for the solvent seamable skin layer in a three layer structure with a core layer comprising a styrene-ethylene-co-butene-styrene or styrene-ethylene-co-propylene-styrene triblock copolymer or styrene-ethylene-co-propylene diblock copolymer in combination with a propylene terpolymer or propylene-ethylene copolymer. Optional components can include a propylene copolymer elastomer with ethylene, a Polybutene-1 copolymer, and/or TiO₂ white concentrate, as described below.

Corona Treatment (optional)

| | | |
|---|---|---|
| ~4-13 μm | skin layer | 35-65% Topas 9605F-500/65-35% Topas 8007F-600 COC |
| 20-45 μm | core layer | 40-65% Kraton G SEBS or SEP or SEPS Block Copolymers |
| | | 20-55% Adsyl 6C30F Terpolymer or Adsyl 7415XCP Copolymer |
| | | 0-30% Vistamaxx 3980FL |
| | | 0-10% LYB Koattro DP8310M Polybutene-1 copolymer |
| | | 0-15% Polybatch White LL8006 CT or 8000 EC TiO2 Concentrate |
| ~4-13 μm | skin layer | 35-65% Topas 9605F-500/65-35% Topas 8007F-600 COC |

Corona Treatment (optional)

### Example 13

Three additional films, identified as Example 13 as a group, were investigated. The films all contained skin layers with 60% Topas 9506F-500 and 40% Topas 8007F-600 COC resin and a core composition containing Kraton G1645 styrene-ethylene-butene-styrene triblock copolymer at a level of 40.5 wt. %, Adsyl 6C30F polypropylene terpolymer at a level of 31.5 wt. %, and Vistamaxx 3980FL propylene copolymer with ethylene at a level of 28 wt. %. The films vary only in the overall film thickness and smaller variations in the skin thickness. Properties are provided in Tables 27 and Table 28 below. Excellent optical properties are observed together with very strong adhesion between the skin and core layers as illustrated by the high level of Z-axis strength shown in Table 27.

TABLE 27

| | Unit of | | | |
|---|---|---|---|---|
| Film Property | Measure | Example 13. Three Layer COC Skins | | |
| Skin Composition | | 60% Topas 9506F-500 and | | |
| | | 40% Topas 8007F-600 | | |
| Core Composition | | 40.5% Kraton G1645/31.5% Adsyl | | |
| | | 6C30F/28% Vistamaxx 3980FL | | |
| Yield | in²/lb | 19,468 | 18,292 | 17,226 |
| Density | g/cm³ | 0.918 | 0.912 | 0.914 |
| Film Thickness | microns | 39 | 42 | 45 |
| (calculated) | | | | |
| Skin Thickness | microns | 8.9 | 10.4 | 12.5 |
| (measured) | | | | |
| Haze | % | 0.7 | 0.8 | 0.7 |
| 45° Gloss - IN | gu | 96 | 96 | 96 |
| Gurley Stiffness | | 3.6/5.3 | 5.2/7.1 | 4.9/8.0 |
| MD/TD | | | | |
| Flex Stiffness | g/in | 1.9/4.6 | 2.0/2.5 | 2.5/6.9 |
| MD/TD | | | | |
| Z-axis Strength | g/in | 689 | 634 | 491 |

The use of styrene block copolymer as the predominant component of the core layer in combination with propylene terpolymer and propylene elastomer provides an exceptional balance of shrink performance (>70% at 95° C.), moderate shrink tension, and very good stability at typical storage temperatures, as illustrated in Table 28 below.

TABLE 28

| | Unit of | | | |
|---|---|---|---|---|
| Film Property | Measure | Example 13. Three Layer COC Skins | | |
| Skin Composition | | 60% Topas 9506F-500 and | | |
| | | 40% Topas 8007F-600 | | |
| Core Composition | | 40.5% Kraton G1645/31.5% Adsyl | | |
| | | 6C30F/28% Vistamaxx 3980FL | | |
| TD Shrink | | | | |
| 65° C. | % | 1 | 1 | 1 |
| 70° C. | % | 8 | 2 | 8 |
| 75° C. | % | 24 | 27 | 26 |
| 80° C. | % | 50 | 55 | 53 |
| 85° C. | % | 60 | 62 | 63 |
| 90° C. | % | 67 | 68 | 67 |
| 95° C. | % | 72 | 74 | 73 |
| 100° C. | % | 76 | 75 | 76 |
| 105° C. | % | 77 | 78 | 77 |
| Shrink Tension TD | | | | |
| 80° C. | grams | 372 | 438 | 410 |
| 85° C. | grams | 432 | 465 | 437 |
| 90° C. | grams | 432 | 439 | 452 |
| 95° C. | grams | 451 | 474 | 431 |
| 100° C. | grams | 425 | 453 | 442 |
| Natural Shrink TD | | | | |
| 30° C. | % | 0.0 | 0.0 | 0.0 |
| 35° C. | % | 0.0 | 0.5 | 0.5 |

### Example 14

Three additional films, identified as Example 14 as a group, were investigated. The films all contained skin layers with 60% Topas 9506F-500 and 40% Topas 8007F-600 COC resin and a core composition containing Kraton G1645 styrene-ethylene-butene-styrene triblock copolymer at a level of 40 wt. %, Adsyl 6C30F polypropylene terpolymer at a level of 25 wt. %, Vistamaxx 3980FL propylene copolymer with ethylene at a level of 25 wt. %, and Polybatch White LL 8006 CT at a level of 10 wt. %. The films vary only in the overall film thickness and smaller variations in the skin thickness. Properties are provided in Tables 29 and Table 30 below. The introduction of a moderate level (7%) of TiO₂ into the core layer via the use of a 70 wt. % TiO₂ concentrate in a LLDPE carrier provides a solid white film with a high degree of opacity and very good interlayer adhesion while maintaining a density below 1 g/cm³ to facilitate separation of the film label from the heavier PETG bottles in a recycling operation.

TABLE 29

| | Unit of | | | |
|---|---|---|---|---|
| Film Property | Measure | Example 14. Three Layer COC Skins | | |
| Skin Composition | | 60% Topas 9506F-500 and | | |
| | | 40% Topas 8007F-600 | | |
| Core Composition | | 40% Kraton G1645/25% Adsyl 6C30F/25% Vistamaxx | | |
| | | 3980FL/10% Polybatch White LL 8006 CT | | |
| Yield | in²/lb | 12,943 | 12,278 | 11,939 |
| Density | g/cm³ | 0.963 | 0.962 | 0.963 |
| Film Thickness | microns | 56 | 60 | 61 |
| (calculated) | | | | |
| Skin Thickness | microns | 11.1 | 9.4 | 10.1 |
| (measured) | | | | |
| Opacity | % | 78 | 77 | 78 |
| 45°Gloss - IN | gu | 59 | 59 | 59 |
| 45° Gloss - OUT | gu | 56 | 58 | 57 |
| Surface Treat (IN) | Dynes | 57 | 57 | 55 |
| Surface Treat (OUT) | | 31 | 31 | 30 |
| Gurley Stiffness | | 13.0/15.2 | 15.1/15.4 | 11.1/13.4 |
| MD/TD | | | | |
| Flex Stiffness | g/in | 4.4/5.8 | 4.2/5.7 | 4.7/6.6 |
| MD/TD | | | | |
| Z-axis Strength | g/in | 211 | 413 | 417 |

The use of a LLDPE carrier for the TiO₂ incorporated into the core layer maintains the shrink performance of the film without detracting from the storage temperature stability of the film, as illustrated in Table 30 below.

TABLE 30

| | Unit of | | | |
|---|---|---|---|---|
| Film Property | Measure | Example 14. Three Layer COC Skins | | |
| Skin Composition | | 60% Topas 9506F-500 and | | |
| | | 40% Topas 8007F-600 | | |
| Core Composition | | 40% Kraton G1645/25% Adsyl 6C30F/25% Vistamaxx | | |
| | | 3980FL/10% Polybatch White LL 8006 CT | | |
| TD Shrink | | | | |
| 65° C. | % | −1 | 0 | 0 |
| 70° C. | % | 4 | 4 | 2 |
| 75° C. | % | 42 | 42 | 42 |
| 80° C. | % | 50 | 51 | 50 |
| 85° C. | % | 61 | 61 | 61 |
| 90° C. | % | 66 | 65 | 65 |
| 95° C. | % | 70 | 70 | 70 |
| 100° C. | % | 72 | 72 | 71 |
| 105° C. | % | 73 | 74 | 73 |
| Shrink Tension TD | | | | |
| 80° C. | grams | 547 | 490 | 523 |
| 85° C. | grams | 556 | 502 | — |
| 90° C. | grams | 547 | 490 | 523 |
| 95° C. | grams | 556 | 502 | — |
| 100° C. | grams | 517 | 505 | 520 |
| Natural Shrink TD | | | | |
| 30° C. | % | 0.0 | 0.25 | 0.0 |
| 35° C. | % | 0.25 | 0.5 | 0.25 |

Once again, the introduction of an opacifying agent into the core while maintaining a density below 1 g/cm³ provides the ability to produce a floatable film which can be separated from non-floatable containers while creating an effective UV and Visible light barrier in applications, such as dairy products, where the container contents are detrimentally affected over time by light exposure in the wavelength range of 200-750 nm. This is illustrated in FIG. 2 below which shows exceptional light blocking performance (below 5% transmission in the range of 200-750 nm wavelength) of the film of Example 14.

In another embodiment of the present invention, three component organic solvent blends usable to form continuous welded seams in accordance with the broadest aspects of this invention have been identified. The blends are based on the combination of one component selected from the class of naturally occurring organic materials known as terpenes, at least one or more components selected from the group consisting of a straight chain ether, a branched chain ether, a cyclic ether, a substituted cyclic ether, a cyclic diether, a substituted cyclic diether, and at least one or more components selected from the group consisting of a straight chain ketone, a branched chain ketone, a cyclic ketone, and a substituted cyclic ketone.

Specific combinations and ratios of one or more terpenes in combination with one and/or the other of cyclic ketones and cyclic diethers have been found to be very effective seaming solvents for polyolefin based shrink film with at least one skin layer comprising at least one styrene copolymer. One or more terpenes in combination with one and/or the other of aliphatic hydrocarbons and cyclic diethers have been found to be very effective seaming solvents for polyolefin based shrink film with at least one skin layer comprising at least one cyclic olefin copolymer. Preferred solvent blends are based on a-Pinene as the terpene component. Films of examples 2-4, 6-7, 9, 11, and 13-14 described previously were hand seamed into shrink sleeves using a laboratory seamer (available from Ryback & Ryback, Inc., Monroe, N.C.). For film samples of examples 2-4 and 6, 7, 9, and 11, a solvent blend of 40 vol % a-Pinene, 30 vol % Cyclohexanone, and 30 vol % 1,3-Dioxolane was used for these seaming evaluations. For film samples of examples 13-14, a solvent blend of 60 vol % a-Pinene, 20 vol % n-Heptane, and 20 vol % 1,3-Dioxolane was used for this seaming evaluation. Seam width for all films was kept within a range of 0.15-0.3 inches (4-7.5 mm). The resulting sleeves were aged at room temperature for several hours prior to T-peel testing on a MTS Q-Test/1 L tensile tester. T-peel results are described in Table 31 below.

TABLE 31

| | | |
|---|---|---|
| Solvent Recipe | Film | T-Peel (g/25 mm) |

| (Vol %) | Designation | Peak | Peel |
|---|---|---|---|
| 40% a-Pinene | Example 2 | 758 | 437 |
| 30% Cyclohexanone | Example 3 | 2283 | 1689 |
| 30% 1,3-Dioxolane | Example 4 | 1121 | 791 |
| | Example 6 | 963 | 396 |
| | Example 7 | 1782 | 1292 |
| | Example 9 | 1277 | 807 |
| | Example 11 | 2189 | 1473 |
| 60% a-Pinene | Example 13 | 766 | 435 |
| 20% n-Heptane | Example 14 | 1072 | 777 |
| 20% 1,3-Dioxolane | | | |

Exceptional high peel strength (Peak and Peel) was observed with the solvent blend selected for both the films with Styrene-butadiene-Styrene skin layers and the films with Ethylene-norbornene skin layers, indicating these films would be suitable for shrink sleeve applications.

In the most preferred embodiments of this invention, the film, with or without a whitening agent therein, is essentially uniaxially oriented. If a voiding agent is included in the structure to provide opacity, it may be desirable to biaxially orient the film to aid in creating voids, and thereby reducing the density of the film.

In general, an opaque shrink film in accordance with this invention provided with a voiding agent have a density less than 1 g/cm³. If a non-voiding, opacifying agent is used in one or more layers thereof, films with high opacity and a density below 1 g/cm³ are possible. Density above 1 g/cm³ is also possible, dependent upon the concentration of opacifying agent incorporated. Non-voiding opacifying agent and voiding agents are well known in the art. By way of example, a non-voiding opacifying agent can include TiO₂ and voiding agents according to this invention include PBT (polybutylene terephthalate) and CaCO₃. This invention is not limited to the use of any specific non-voiding opacifying agent and/or voiding agent; the particular agent(s) selected being within the general skill of the art.

Although the present invention has been described in connection with preferred embodiments thereof, it will be appreciated by those skilled in the art that additions, modifications, substitutions, and deletions not specifically described may be made without departing from the spirit and scope of the invention defined in the appended claim.

What is claimed is:

1. A multilayer oriented shrink film comprising:
a base layer; and
a first skin layer on a first side of the base layer and comprising at least one amorphous styrene-butadiene block copolymer or at least one amorphous cyclic olefin copolymer,
wherein the base layer has a thickness greater than the first skin layer and comprises a blend of: (a) at least one styrene block copolymer selected from the group consisting of styrene-ethylene/butene-styrene triblock copolymers, styrene-ethylene/propylene-styrene triblock copolymers, styrene-ethylene/butene diblock copolymers and styrene-ethylene-propylene diblock copolymers and combinations thereof; and (b) at least one propylene polymer selected from the group consisting of polypropylene terpolymers with ethylene and butene-1, propylene ethylene copolymers, propylene butene-1 copolymers and combinations thereof.

2. The multilayer oriented shrink film of claim 1, including a second skin layer on a second side of the base layer opposite to the first side of the base layer, wherein the second skin layer comprises at least one amorphous styrene-butadiene block copolymer or at least one amorphous cyclic olefin copolymer.

3. The multilayer oriented shrink film of claim 1, including a second skin layer on a second side of the base layer opposite to the first side of the base layer, wherein the second skin layer has a composition identical to a composition of the first skin layer.

4. The multilayer oriented shrink film of claim 1, having a density of less than 1 g/cm³.

5. The multilayer oriented shrink film of claim 1, wherein the base layer further comprises a polypropylene copolymer elastomer.

6. The multilayer oriented shrink film of claim 1, wherein the base layer further comprises a polybutene-1 copolymer.

7. The multilayer oriented shrink film of claim 1, having a haze less than 6%.

8. The multilayer oriented shrink film of claim 1, wherein a predominant film orientation is in a transverse direction, and the film has a transverse direction shrink level in excess of 50% at 95° C.

9. The multilayer oriented shrink film of claim 1, wherein a predominant film orientation is in a transverse direction, and the film has a transverse direction shrink level in excess of 60% at 95° C.

10. The multilayer oriented shrink film of claim 1, wherein the film is uniaxially oriented in a transverse direction, and the film has a transverse direction shrink level in excess of 50% at 95° C.

11. A multilayer oriented shrink film comprising:
(A) a base layer comprising:
(i) at least one styrene block copolymer selected from the group consisting of styrene-ethylene/butene-styrene triblock copolymers, styrene-ethylene/propylene-styrene triblock copolymers, styrene-ethylene/butene diblock copolymers, styrene-ethylene-propylene diblock copolymers and combinations thereof;
(ii) 20% to 55% at least one polypropylene polymer selected from the group consisting of polypropylene terpolymers with ethylene and butene-1, propylene ethylene copolymers, propylene butene-1 copolymers and combinations thereof; and
(iii) at least one of: (a) 1% to 30% of a polypropylene elastomeric copolymer, and (b) 1% to 10% of polybutene-1 with ethylene; and
(B) at least one skin layer which is disposed upon at least one side of the base layer, wherein the at least one skin layer comprises at least one amorphous styrene-butadiene block copolymer or at least one amorphous cyclic olefin copolymer, and wherein the base layer has a thickness greater than that of the at least one skin layer
wherein the at least one styrene block copolymer constitutes 45%-75% of the base layer when the at least one skin layer comprises the at least one amorphous styrene-butadiene block copolymer, and the at least one styrene block copolymer constitutes 30%-75% of the base layer when the at least one skin layer comprises the at least one amorphous cyclic olefin copolymer.

12. The multilayer oriented shrink film of claim 11, having a haze less than 6%.

13. The multilayer oriented shrink film of claim 11, wherein a predominant film orientation is in a transverse direction, and the film has a transverse direction shrink level in excess of 50% at 95° C.

14. The multilayer oriented shrink film of claim 11, wherein a predominant film orientation is in a transverse direction, and the film has a transverse direction shrink level in excess of 60% at 95° C.

15. The multilayer oriented shrink film of claim 11, wherein the film is uniaxially oriented in a transverse direction and has a transverse direction shrink level in excess of 50% at 95° C.

16. The multilayer oriented shrink film of claim 11, which comprises: (a) 1% to 30% of the polypropylene elastomeric copolymer, but not (b) 1% to 10% of the polybutene-1 with ethylene.

17. The multilayer oriented shrink film of claim 11, which comprises: (b) 1% to 10% of the polybutene-1 with ethylene but not (a) 1% to 30% of the polypropylene elastomeric copolymer.

18. The multilayer oriented shrink film of claim 11, which comprises: (a) 1% to 30% of the polypropylene elastomeric copolymer, and (b) 1% to 10% of the polybutene-1 with ethylene.

19. The multilayer oriented shrink film of claim 11, having a haze less than 3%.

20. The multilayer oriented shrink film of claim 11, having a haze less than 2%.

21. The multilayer oriented shrink film of claim 11, wherein the base layer further comprises a non-voiding opacifying agent.

22. The multilayer oriented shrink film of claim 21, wherein the film has a density of less than 1 g/cm³.

23. The multilayer oriented shrink film of claim 22, wherein the film has a UV-Visible light transmission at wavelengths between 200 nm and 800 nm of less than 10%.

24. The multilayer oriented shrink film of claim 22, wherein the film has a UV-Visible light transmission at wavelengths between 200 nm and 800 nm of less than 15%.

25. The multilayer oriented shrink film of claim 22, wherein the film has a UV-Visible light transmission at wavelengths between 200 nm and 800 nm of less than 1%.

26. A shrink label comprising a multilayer oriented shrink film of claim 1, wherein the label is configured to be wrapped about a peripheral surface of an article with one end of the label overlapping and sealed to an outer surface of the first skin layer at an opposite end of the label, and wherein the outer surface of the first skin layer is capable of being tackified by a solvent blend so as to adhere to the one end of the label.

27. The shrink label of claim 26, wherein the first skin layer includes a cyclic olefin copolymer therein.

28. The shrink label of claim 26, wherein first skin layer includes an amorphous styrene-butadiene block copolymer therein.
